(19) United States
(12) Patent Application Publication
(10) Pub. No.: US 2012/0218277 A1
(43) Pub. Date: Aug. 30, 2012

(54) DISPLAY LIST MECHANISM AND SCALABLE DISPLAY ENGINE STRUCTURES

(75) Inventors: NOELIA RODRIGUEZ MATILLA, LUND (SE); TORBJÖRN SVENSSON, LUND (SE); ERIK LEDFELT, VELLINGE (SE)

(73) Assignee: ST-ERICCSON SA, Plan-les-Ouates (CH)

(21) Appl. No.: 13/035,636

(22) Filed: Feb. 25, 2011

(51) Int. Cl. G06F 13/14

(52) U.S. Cl. 345/520

(57) ABSTRACT

A display list with slot instructions is provided to interface between platform software and a display engine. A display list interface is created for each frame of image data that is to be updated and displayed on a display. In some circumstances, the display list may be reused for subsequent frames, for example, when generating a stream of video images for a video mode display showing a static image. A display list may be part of the interface between a software driver and a scalable display engine architecture that has multiple repetitive processing blocks enabling the same or multiple frames to be processed in parallel to produce update frames for one or more display devices.

### TECHNICAL FIELD

This invention relates generally to an apparatus and method for processing graphic display image data, and more particularly to a display engine interface, display engine apparatus and methods of interfacing platform software with a scalable display engine architecture in order to control image frame generation for one or more displays.

### BACKGROUND

A display engine generally comprises electronic circuitry found in or associated with video or other graphics circuitry. A display engine generally couples image memory or other image source data to a display device such that video or image data is processed and properly formatted for a particular display device. A display engine is used to convert image data that is retrieved from image memory into digital video or graphic display data that can ultimately be provided to a display or display device.

A display or display device may be substantially any graphic display device along with its immediate circuitry. Examples of display devices include raster televisions, CRT devices, LCD display panels, LED display panels, mobile device display screens, consumer product display screens, OLED displays, projection displays, laser projection displays and 3-D display devices. A display device may be an output device used to present information for visual, and in some circumstances, tactile or auditive reception.

Existing hardware implementations of display engines are typically tightly coupled to the number of display threads that need to be processed in parallel. Internal blocks of prior art display engines are each dedicated to one specific display thread with little or no resource mechanism that allows an internal block used to process one display thread to be used by another parallel processed display thread when that the internal block is inactive.

The software stack, used in prior hardware implementations of display engines, is setup and programmed to be aware of the specific implementation details of the display engine's hardware processing blocks such that the software stack instructions manage each parallel display thread individually. Set up and control of these preexisting hardware display engines is performed through direct interaction or access between the software stack instructions and the registers of each processing block of the display engine.

Prior existing hardware implementations of display engines have various drawbacks and problems. First, hardware implementations of prior existing display engines (i.e., the number of processing blocks or registers needed) are tightly coupled to the specific requirements (i.e., performance, physical hardware size limitations, and supported display devices) of its target system or platform. As such, significant hardware redesign and control software changes are required in order for prior existing display engines to be modified for implementation in a different system or platform.

Second, prior existing display engines each require significant development and design time. The significant development and design time is partially due to needing to know the final or near final hardware architecture implementation of the display engine in a platform prior to being able to proceed with development of the software that interacts with the display engine

Thirdly, modifications to a prior existing display engine's hardware blocks or to its implementation details often requires detailed time consuming changes to the control mechanism of the software stack instruction's direct coupling to specific display engine hardware block registers. Thus, seemingly simple display engine hardware implementation modifications add significant development time, costs and error risks to altered display engine designs.

Therefore, a need exists for a display engine design and control mechanism that allows for a scalable and flexible display engine design having a standardized interface control mechanism between the system's or platform's software instructions and the display engine registers.

### SUMMARY

Embodiments of an exemplary display engine comprise an interface control mechanism, based on instruction lists, that operates as an interface between platform software or software drivers and a display engine. Embodiments of an exemplary interface control mechanism operate independently from the integral display engine details. An exemplary interface control mechanism interfaces with a display engine without regard for the display engine's architecture or the number of instantiated display engine processing blocks. Embodiments also provide an exemplary scalable display engine design that has the flexibility to fit or be utilized in multiple implementation variations without undue redesign. Embodiments allow for early design stage platform or system software/firmware development without having to wait for display engine hardware implementation. Also, the number of complex later design stage modifications to a display engine design caused by late specification changes is reduced. Display engine embodiments include exemplary display engine hardware architectures, which operate by interfacing with software or display engine drivers via an exemplary control mechanism or software interface.

Additionally, various exemplary display engines require a minimum of memory resources, while supporting total scalability, with respect to the number of display threads being processed in parallel through the display engine. Embodiments include techniques for display thread synchronization and job prioritization with respect to other display threads via an exemplary display list interface, which frees the overall device processor or display engine driver from having to directly control the priority given to each display thread processed by the display engine's processing blocks.

In one embodiment, a method of controlling a display engine is provided. The method comprises providing, by software, a display list that is adapted to configure a plurality of display engine processing blocks. The display list comprises a plurality of slots that are adapted to instruct the plurality of display engine processing blocks to compose an image frame from some source image data. Source image data may comprise a plurality of source image data frames. The display list is stored in memory. The display engine uses at least one of the plurality of slots to process some of the source image data (i.e., a source image data frame) into an image frame that may be displayed on a particular display. The image frame may then be provided to a display engine output. In other words, the image data is processed according to at least one slots of the display list such that the resulting image frame is formatted appropriately to be sent to an output or outputs and/or to a memory area simultaneously.

The memory used to store the display list may be either a memory that is internal or external to the display engine circuitry or chip. Exemplary display engine circuitry may be incorporated into a single chip integrated circuit solution or be part of a multi-chip display engine solution. Internal memory is memory that is part of the single or multi-chip display engine circuit.

The exemplary display list may be provided by software or a software driver that operates external to the display engine. Furthermore, the steps of providing the display list, storing the display list and composing the image frame may each be performed and repeated for each frame of source image data that is to be displayed on a display or stored into memory for display at a later time.

An exemplary display list comprises a plurality of slots. At least one of the slots may provide instructional information associated with how the display engine processes a plurality of tiles derived from an image frame. A frame may be comprised of a plurality of tiles. Each tile may be processed individually by an exemplary display engine in accordance with certain slot instructions or parameters. Each processed tile (update tile) may be temporarily stored in a FIFO prior to being combined with other tiles of the same frame. The combined tiles of the same frame may then be provided as an image frame to the output of the display engine ultimately for display on a display device or for storage in a memory area. The display list slots associated with tiles may provide general instructions for processing tiles of an entire frame thread rather than providing instructions or settings for individual tiles.

An exemplary display list may further comprise at least one slot instruction having instructional information associated with how the display engine should format an image frame. Embodiments may further comprise slots that provide instructional information indicating a starting memory location(s) of the source image frame data that is to be processed by the display engine in accordance with the display list. Each frame of source image frame data is generally processed by the display engine in accordance with a different display list. In some embodiments, when the source image frame data is the same for several frames, processing time may be saved by using the same display list (e.g., a static display list) or a slightly modified display list instead of creating an entirely new display list for each frame.

Another embodiment provides a software interface between software and a display engine architecture. The display engine architecture comprises a plurality of hardware processing blocks and an internal memory. The software interface comprises a memory portion of the internal memory and a first display list. The first display list comprises a first plurality of slots. The first display list is configured according to a predetermined format and is adapted to be stored in the memory portion of the internal memory of the display engine architecture. The plurality of slots are adapted to be read from memory by the display engine and to set up the display engine architecture to process and format a first frame thread of source image data into a first image frame. The first image frame may be provided to a first predetermined display device or to memory.

The exemplary software interface between software and the display engine architecture may support and be useable by a plurality of display engine designs, which is the result of the display engine architecture being a scalable display engine architecture design. An exemplary scalable display engine design comprises a plurality of processing blocks that may include at least one pixel pipeline block that is adapted to compose first individual image tiles from the first frame thread of image data into first update tiles. At least one tile FIFO is adapted to receive the first update tiles from at least one of the pixel pipeline blocks. At least one display refresh block is adapted to receive and format the first update tiles from a selected one of the tile FIFOs into the first image frame. And, a scheduling block is adapted, in accordance with the first display list, to control and synchronize movement of the first frame thread of source image data to at least one pixel pipeline block, control and synchronize movement of the first update tiles to the at least one tile FIFO, control and synchronize movement of the first update tiles from the selected one of the tile FIFOs to the at least one refresh block, and movement of the first image frame to the selected display output. The scheduling block can be further adapted to control and simultaneously synchronize movement of the first image frame to the first selected display output as well as to a second selected display output or memory area.

The exemplary software interface between software and the display engine architecture may interface an exemplary display engine with software that is display engine driver software, which operates externally from the display engine.

The software interface between software and the display engine architecture may further comprise a second display list that comprises a second plurality of slots associated with a second frame thread. The second display list, like the first display list, is adapted to be stored in a portion of the internal memory of the display engine architecture. The second plurality of slots are configured according to the predetermined format and are adapted to set up the display engine architecture to process and format a second frame thread of source image data into a second image frame to be provided to a second predetermined display device. The slots of the first and the second plurality of slot instructions may be used by the processing blocks of the display engine architecture to process the first and second frame threads in parallel.

In some embodiments, the first and second predetermined display device are the same display device.

In some embodiments, the first display list temporarily becomes a static display list that remains stored in the memory portion and is adapted to set up the display engine architecture process and format a second frame thread of source image data into a second image frame to be provided to the first predetermined device.

In yet another embodiment of the software interface between software and a display engine architecture, the display engine architecture is a scalable display engine architecture comprising at least two pixel pipeline blocks, wherein each pixel pipeline block is adapted to compose first update tiles from the first frame thread of source image data or to compose second update tiles for a second frame thread of the source image data. The scalable display engine architecture further comprises at least two tile FIFOs, wherein each tile FIFO is adapted to receive the first update tiles from at least one of the pixel pipeline blocks or to receive the second update tiles from at least one of the pixel pipeline blocks. There are also at least two display refresh blocks. Each display refresh block is adapted to receive first update tiles of the first frame thread from a first selected one of the at least two tile FIFOs or to receive second update tiles of the second frame thread from a second one of the at least two tile FIFOs, and wherein each display refresh block is further adapted to format first update tiles of the first frame into first image frames and adapted to format second update tiles of the second frame into second image frames. The exemplary scalable display engine architecture also comprises a scheduling block that is adapted to control and synchronize operation of each pixel pipeline block and each display refresh block based on both the first display list and the second display list.

In yet another embodiment of the invention an interface between software and a display engine architecture is provided. The interface comprises both a display list memory adapted to receive and store at least one display list and a first display list that is provided by software that operates external to the display engine architecture. The first display list is adapted to be stored in the display list memory. The first display list is associated with a first frame thread of source image data. The first display list further comprises informational instructions or parameters adapted for use by the display engine architecture to set up the display engine architecture to process the first frame thread of source image data. In some embodiments, the display list memory is located on-chip or internal to the display engine architecture. Such a display list memory may be considered as internal memory. The display list comprises slots of informational instructions or parameters. A scheduling block and associated register locations are part of the display engine architecture. The scheduling block and associated register locations operate as a means for setting up the display engine architecture to process the first frame thread of image data using the informational instructions of the first display list. The informational instructions may be configured into instructional slots. Furthermore, the display list's informational instructions or parameters may be created in accordance with a display engine interface standard adapted for use as part of a display list and for interfacing with any of a plurality of display engines or display engine architectures.

In yet another embodiment, the interface between software and a display engine architecture may further comprise a second display list provided by the software such that the second display list is adapted to be stored in the display list memory and is associated with a second frame thread of source image data. The second display list comprises informational instructions or parameters adapted for use by the display engine architecture to set up the display engine architecture to process the second frame thread of source image data in parallel with the first frame thread of image data.

### BRIEF DESCRIPTION OF THE DRAWINGS

For a more complete understanding, reference is now made to the following description taken in conjunction with the accompanying Drawings in which:

FIG. 1 illustrates an exemplary frame divided into a plurality of tiles wherein update rectangles represent areas in the frame;

FIG. 2 illustrates a block diagram of an exemplary single thread display engine architecture in accordance with an embodiment of the invention;

FIG. 3 illustrates a block diagram of an exemplary display engine architecture that updates one display device and comprises a plurality of compositions blocks, a scheduling block and a refresh block that can parallel process a plurality of update tiles for an update or image frame;

FIG. 4 illustrates a block diagram of an exemplary display engine architecture that supports the parallel execution of several image threads simultaneously for more than one display device; and

FIG. 5 illustrates a block diagram of a scalable display engine architecture that interfaces with an exemplary display list; such architecture may substantially replicate the pixel pipeline blocks and display refresh blocks for use in different platforms requiring different performance parameters.

### DETAILED DESCRIPTION

Referring now to the drawings, wherein like reference numbers are used herein to designate like elements throughout, the various views and embodiments of a display list mechanism interface for scalable display engines are illustrated and described along with other possible embodiments. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

A display engine is generally part of a system's or platform's video or graphics display circuitry. A display engine is generally connected to communicate with image memory, a memory controller, and a graphic display device. Image memory is memory that contains image data that is to be processed and displayed on a display device. An exemplary display engine typically converts source image data received from image memory via a memory controller to digital video or graphic image frame data so that it may be fed to a display or in some embodiments back to memory for displaying at a later time.

Embodiments of the invention provide a flexible interface mechanism that uses one or more display lists to program or control a display engine. Embodiments may also include exemplary display engine architecture that utilizes the exemplary interface mechanism. An exemplary display list contains configuration data or parameters, which define the attributes and behavior of a display engine while processing a frame of image data (also referred to as a frame thread). An exemplary display list does not include initialization or setup information for setting up the various display engine processing blocks. By not including initialization or set-up information in an exemplary display list, the display list may be a complete abstraction and separate from a display engine's physical implementation details. As such, an exemplary display list does not allow software that is external to a display engine, to interface directly with the registers of each processing block of an exemplary display engine.

An exemplary display list comprises a list of instructions or parameters, which were created by a display engine driver or other software, that are written in memory. The display list instructions are read sequentially from memory by a display engine's scheduling block and optionally by one or more of the other display engine processing blocks. Furthermore, each display list instruction is read by a processing block such that the information within the display list instruction (i.e., the parameters comprised within each display list instruction) is stored in internal processing block registers. Several processing blocks may read the same display list instruction. As such, the display list instructions are provided or made available, directly or indirectly, to registers of the various processing blocks of a display engine. The instructions or parameters prescribe how to generate an image frame for a specified display device. An image frame is organized image data used to produce an image displayed on a predetermined display device. Digital video data is generally a plurality of image frames sequentially displayed on a display device.

Each display list instruction is referred to as a “slot”. Slots are specifically formatted instructions or parameters that are meant to interface with the display engine hardware. By establishing a standardized slot format or configuration, a reduced effort is needed from hardware design or ASIC design engineers and software engineers to create new systems for translating the software stack or software of a platform's operating system into instructions that control a display engine. Furthermore, there is a reduction in the risk of introducing errors derived from incorrect software conversion drivers, which are used to convert software stack instructions into display engine instructions suitable for the specific display engine design.

When the slots of a single display list are executed by a display engine, the overall outcome is typically the generation of an image frame. An image frame is a single image that may be viewed on a display. The composition of a frame may be split into multiple display engine jobs. A job may comprise the processing of a single frame tile. A tile is a rectangular area in the display frame. A tile is an area of the display that can be individually updated by an exemplary display engine. To simplify this description, it will be assumed that all the tiles that make up a frame have the same shape and size. Having the same shape and size allows for scalability of the tiles and simplifies the overall implementation. Tiles may be substantially any multi-sided geometric shape such as squares, rectangles, triangles, octagons, pentagons, that can be tiled integrally together to form a complete frame. Again, for simplicity of description, we will assume herein that tiles are square.

There are various type of slots needed in a complete exemplary display list used by a display engine to create an image frame. An image or update frame is a new or next frame that replaces the frame being displayed on the display. Generally, the different types of slots needed to create an image frame are synchronization slots, configuration slots, frame update slots, composition slots, refresh slots and memory management slots.

The purpose of a synchronization slot is to control the timing of the display list's execution in the display engine. Synchronization slots also may enable synchronization of image frame creation with events such as sounds or mechanical movements external to the display engine. Synchronization slots also connect or coordinate several display lists being processed in parallel (affecting the same or different displays) with each other. For example, a single desktop computer that incorporates an exemplary embodiment may output display signals to one, two or more displays screens that each require the same or different image frame data formats.

Configuration slots include general frame creation informational instructions or parameters that are not necessarily related to a specific frame, but instead to all the frames destined for a same display device. For example, configuration slots may provide information about the display's dimensions, tile shape, pixel density or color range availability. Configuration slots may also contain a priority parameter. A priority parameter provides the display list with information about the importance of a certain frame job or tile over another so that the display engine will process the frame or tile treads in accordance with the priority.

Frame update slots are used to define the area(s) of the display to be updated. An area of the display (or frame) may be defined using, for example, coordinates, tile numbers, or vector information relevant to the placement, size or position of the area to be updated. The frame update slots further define which composition slots and refresh slots from the display list should be used to update the defined area(s) (e.g., update rectangles) of the display that require updating. Frame update slots normally include parameters that indicate whether data structures (e.g., coefficient tables) should be re-read from memory or if the data cached in memory from a previous frame update is still valid because, for example, the tiles associated with the cached data are not going to be changed in the new update or image frame.

Composition slots contain informational instructions related to how a frame is to be composed. For example, a composition slot contains an indication of how many layers are to be processed, the various positions or locations on the display, the resizing and/or scaling of the input layers and the color rendering settings for the frame.

Refresh slots specify how the composed image frame data should be transferred to the display. For example, a refresh slot will prescribe the color format for which the tiles should be sent to the display, commands for the insertion of tiles into a frame, statistics generation and select whether to format the image frame for a display or to be mapped to memory.

Memory management slots are used to specify memory data transfer commands within the display list instructions. Use of memory management slots in the exemplary display list instructions helps reduce the needed size of internal display engine memory, which typically increases the manufacturing cost of display engine chips.

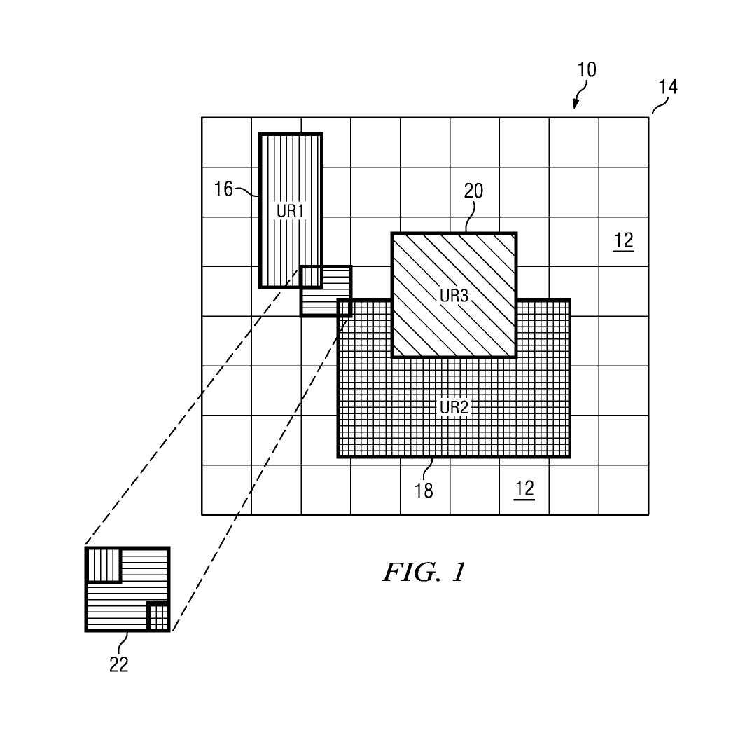

Referring to FIG. 1, an exemplary display screen 10 is shown displaying a single frame 14. The display screen 10 and frame 14 are divided into rows and columns of equally sized tiles 12. The rows and columns of tiles 12 are organized to create the frame 14 on the display 10. Each tile 12 is a portion of the overall frame 14. Each tile may be designated by a number, location or coordinates.

The execution of an exemplary display list, by a display engine (and perhaps a display engine driver) maps all image frame data via tiles to all of or portions of a frame 14. The mapping of image frame data to a frame is referred to as a frame update. A frame update does not necessarily have to update all the tiles in a complete frame 14. A frame update may update only part of the frame 14. Each area of the display that needs to be updated is called an update rectangle 16, 18, 20. FIG. 1 depicts a first update rectangle 16, a second update rectangle 18, and a third update rectangle 20 within frame 14. The embodiments simplify the design and processing effort required to update a display 10 or frame 14 by dividing the frame 14 into tiles 12 that are created by a standardized display engine interface mechanism. For each tile that requires an update, the tile may be updated once for each update rectangle that overlaps the tile. For those tiles with more than one update rectangle 22 affecting or overlapping their area, then such tile 22 will be processed multiple times (e.g., one time for each update rectangle affecting or overlapping as shown in the tile 22) to create a resulting update tile for the image frame.

Embodiments of the invention also provide a novel caching mechanism. The caching mechanism is based on the software stack or display engine driver indicating to the display engine, via a slot instruction, that the content of an area in memory has changed with respect to the last frame. The memory content change is indicated by using dirty bits. Dirty bits are parameters in a frame update slot of the display list. There will be a dirty bit parameter for each memory area that may be reused by the display engine. For example, an embodiment may utilize a linearization table dirty bit. The linearization table dirty bit may indicate whether or not the table of coefficients have been modified. For example, a value of 0x0 for that bit in the display list may indicate that the content of the linearization table has not changed and does not need to be updated or reloaded. Thus, cached data from the last frame can be reused in the current frame. In some embodiments, when a composition block interprets a linearization table, and in particular, the specific address of interest from the display list, the composition block will compare the table's contents with the previous table's contents that it used (i.e. that it read while composing the previous tile). If the addresses match, then there is no need to reload the table of coefficients again because the dirty bit indicates that the data contents has not changed since the last tile update. If the addresses differ, the composition block will interpret the change of address as being a different table and the coefficients for the update tile that is being processed will be loaded. If, on the other hand, the addresses are the same, but the dirty bit is set to 0x1, the values should be reread from memory as they have been modified.

Using this caching mechanism, the number of memory accesses for slot parameters is reduced because such memory accesses need only occur for slot parameters (e.g., coefficient tables, resize filters, color conversion parameters, etc) that have changed and does not occur when such parameters associated with a frame's data for an update tile is unchanged from the last frame update. Thus, such memory accesses are limited to being done only when necessary. In additional embodiments, a display list may be saved in memory and reused as a static display list for use in processing one or more subsequent consecutive frames: i. when a static image is to be displayed on the display, or ii. when subsequent source image data frames are either identical or are to be processed by the display engine in an identical manner. Use of a static display list further minimizes memory update processes and increases image processing efficiency.

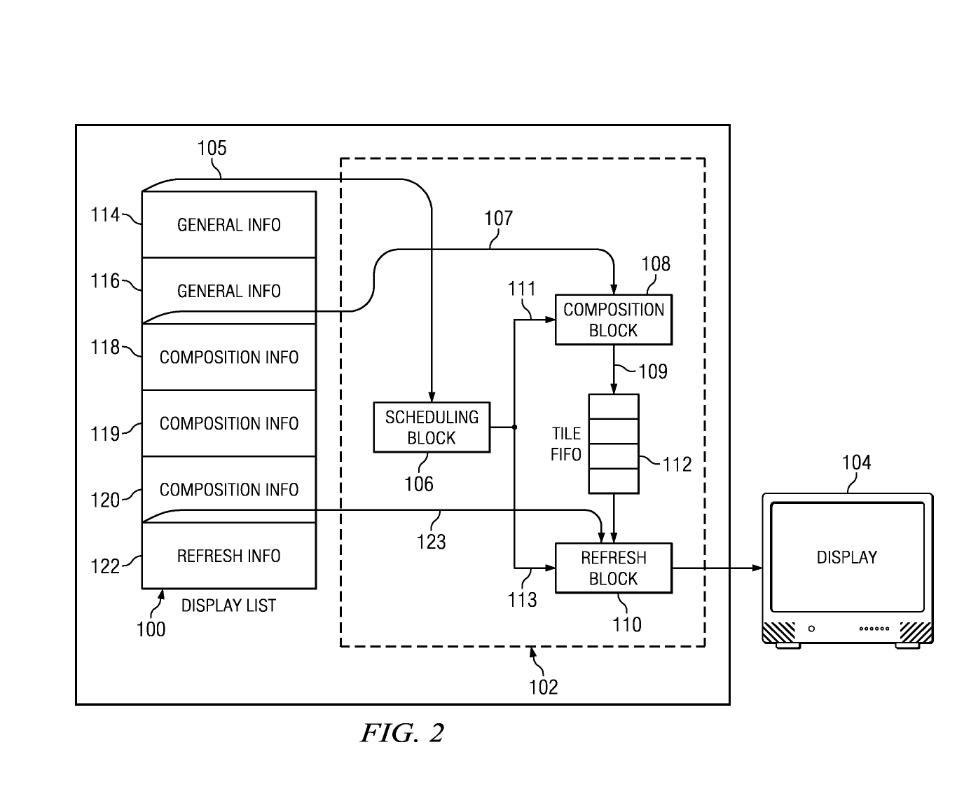

Embodiments of the exemplary display list mechanism may be used as an interface or software interface with a generic display engine. Embodiments may support, providing updated image data while balancing the job or tile composition refresh threads over a plurality of parallel composition or pixel pipeline circuit blocks within the display engine. Thus, the source image frame threads may provide display updates to tiles in the image frames of one or more different displays. FIGS. 2, 3 and 4 show embodiments of the exemplary display list mechanism interfacing with various exemplary display engine architectures in accordance with embodiments of the invention.

FIG. 2 depicts an exemplary display list mechanism or interface that is being utilized with a simple or basic display engine 102. The display engine 102 comprises a single update and refresh thread path for updating frames displayed on a single display 104. The exemplary display engine 102 comprises a scheduling block 106, a composition block 108, a refresh block 110 and a tile FIFO 112.

The scheduling block 106 reads or receives information in its registers from the display list 100. Based on the slot instructions that the scheduling block 106 receives 105, the scheduling block 106 controls the source image data flow from image memory (not specifically shown) through the various blocks of the display engine 102 and out to the display 104. In this embodiment, the scheduling block 106 receives 105 information from the general information slots 114, 116. A general information slot 114, 116 may comprise synchronization slot instructions, frame update slot instructions, configuration slot or memory management slot instructions. The remaining two types of slot instructions in the display list, being composition slots and refresh slots are used by the composition block 108 and the refresh block 110, respectively. The scheduling block 106 may also provide timing instructions to the registers (not specifically shown) of the composition block 108 and refresh block 110.

The general information slots (i.e. synchronization slots, configuration slots, frame update slots, and memory management slots) define the timing of the display list execution, the synchronization of data with external events outside of the display engines, the display 104 dimensions and pixel densities, the priority of frame update parameters with respect to other frame update parameters, and coordinates memory data transfers between external memory, internal memory, the composition block 102 and tile FIFO 112.

Since there is only one composition block 108, only one tile 12 of the frame 14 can be composed or processed at a time and then placed in the tile FIFO 112. Composition info slots 118, 119 and 120 are provided 107 to the composition block 108 registers by the scheduling block 106 in order to define how the overall frame should be composed such that each tile in the frame is composed in the same manner as the other tiles in the frame. The composition block 108, via the display list's slots and information or parameters passed 111 to the composition block registers from the scheduling block 106, determines the source layers, the position of each tile update in the display, the resizing of update tiles and various blending and color options of the pixels in an update tile. Update tile information is loaded 109 from the composition block 108 into the tile FIFOs 112. The refresh slot information 122 is provided 123 to refresh block 110 registers to specify how the composed tile information from the tile FIFOs 112 should be transferred to the display. Meanwhile, the scheduling block 106 may also be instructing 113 the refresh block 110 when to transfer the tiles, in the format of a frame, toward the display 104. The refresh slot 122, via slot specification, establishes the color format, command insertion, memory address location and output format of the image information for organizing the refresh tiles in the update rectangles within a frame of the display 104.

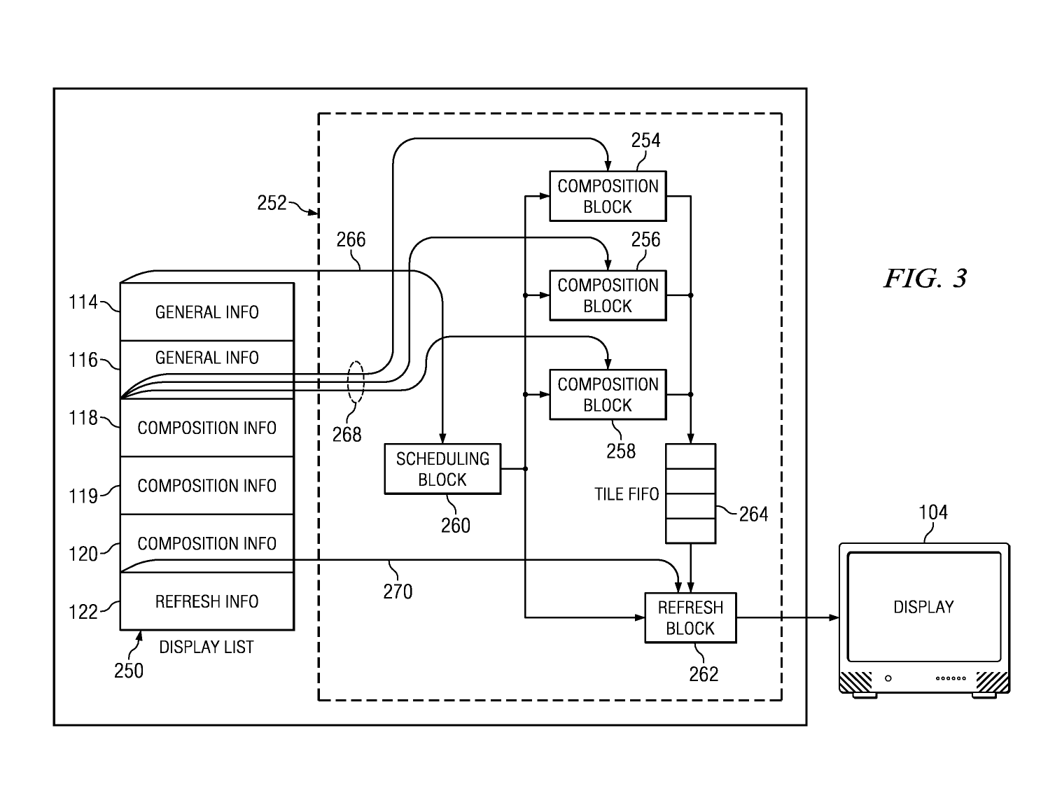

Referring now to FIG. 3 another exemplary display list 250 is shown interfacing with an exemplary display engine 252. This embodiment is similar to the embodiment of FIG. 2 in that it supports the update of one display device 104, but this embodiment includes a plurality of composition blocks 254, 256 and 258, which each process different update tiles in parallel. The update tiles being processed may be for the same frame update or different frame updates. The exemplary display engine also comprises a scheduling block 260, a refresh block 262 and tile FIFOs 264. The scheduling block 260 controls the data flow through the display engine 252 based on the information read from or provided by the display list 250. The scheduling block 260 reads general information slots, which include synchronization slots, frame update slots, configuration slots and memory management slots. The scheduler 260 uses the general information slots from the display list to handle the coordination of the plurality of tiles being produced by all the composition blocks 254, 256, 258. The scheduler further provides the proper position data for placing tile data in the FIFO 264 such that the refresh block 262 can extract the tile FIFO data 264 in the correct order when transferring an update frame (i.e., image frame) to display 104.

In this embodiment, all of the composition blocks use the same general information slots 114, 116 from the display list 250 because the general information slots 114, 116 prescribe how to generate the frame on the display 104. Meanwhile, the information prescribing how to generate update tiles comes from the scheduler block 260. Such information about creating update tiles in a specific frame will be uniform throughout all the tiles of the specific frame.

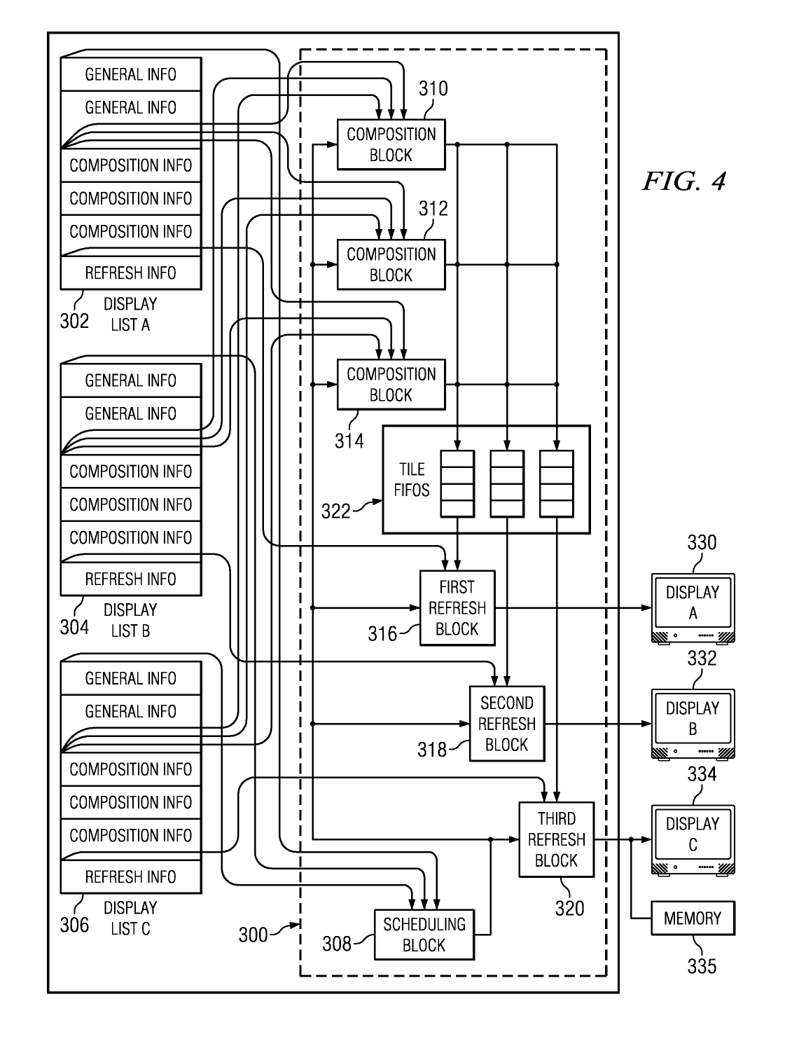

Still referring to FIG. 3, embodiments of the invention provide an interface or software interface between a display engine driver and display engine hardware. A display engine driver may utilize the slots of the display list 250, which is stored in memory. The display list 250 is an interface means, between software and a display engine, for controlling a scalable display engine having various configurations. For example, an exemplary display engine may be structurally similar to the exemplary display engine 102, the display engine 252 or display engine 300 of FIG. 4. The display list or interface means establishes a standardized interface and instructions set for use between any platform and its software and a display engine that formats image data for a display connected to the platform.

A display engine may be an electronic engine for handling graphic or display data, originating from a camera, memory or memory device, which is ultimately intended to be displayed on or via a graphic display device. Embodiments of an exemplary display list provides a standardized format for a display list that comprising instruction slots that are stored in memory and organized in a manner to control the hardware of a scalable display engine architecture. An exemplary display list comprises multiple slots or instructions that combine to specify or describe the totality of an image frame composition that may be output to a display device. The informational instructions within the display list slots are provided both directly and indirectly to the various registers of the display engine hardware blocks (i.e. the scheduling block, composition blocks and refresh blocks) such that the process of creating or updating tiles from source image or source frame data is done by the display engine hardware without intervention from a display engine software driver or external software, since the instructions within the display list's slots are for an entire frame and are provided from the software or display engine driver via a single display list for each update or image frame. The slot instructions for each update frame are read or used by the display engine hardware blocks to update the specified source image data frame into update tiles and ultimately an image frame. By using an exemplary display list as the interface mechanism between the display engine driver and the display engine hardware, once the display list information is written to the hardware blocks for the particular frame thread, the blocks operate synergistically to update the tiles of a frame without additional display driver or external software intervention. In embodiments of the invention, a display engine driver is software that updates the display list for each image frame while initiating the hardware of the display engine to execute a frame update process using the informational instructions or parameters found in the slots of the display list associated with the frame.

Still referring to FIG. 3, the display engine driver writes the display list 250 into predetermined address locations within memory. The scheduling block 260 is informed, via a memory address placed in a register, where in memory to find the display list 250. The memory used to store the display list is preferably internal memory, but in some embodiments may be external memory. An exemplary display list 250 is updated by the display engine driver prior to updating each frame. An exemplary display list comprises instruction slots 114, 116, 118, 119, 120, 122, which contain information about how a particular frame is to be processed and then composed on a display 104. General information slots 114, 116 may be comprised of synchronization slots, configuration slots, frame update slots and/or memory management slots, which contain information that is used mainly by the scheduling block 260. The scheduling block 260 comprises a plurality of registers. One of the registers holds the memory address of the beginning of the display list to be used for creating the associated updated image frame to be output from the correct source image frame data.

After the memory address of the display list's beginning is registered, the display engine driver will instruct the scheduling block 260 to start processing the next source image data frame into the updated next image frame. The scheduling block will begin reading the display list 250 from the designated beginning address. Configuration parameters from configuration slots within the general information slots 114 and 116 are loaded 266 into predetermined scheduling block registers.

The scheduling block 260 will then provide instructions or parameters to the plurality of composition blocks 254, 256 and 258 and instruct the composition blocks to each update different tiles in the designated frame. Composition parameters 268 are loaded from the composition information slots 118, 119 and 120 into predetermining registers of the composition blocks 254, 256, 258. Note that the same composition parameters are loaded into each of the composition blocks. This is because the composition parameters define generally how all the tiles of the frame are to be composed regardless of which composition block composes or processes the update tile. A composition block, for example composition block 254, collects source image frame data from an external memory (not specifically shown) and creates an update tile from the frame thread of source image data (frame thread), which the scheduling block 260 has instructed it to update for inclusion in an update image frame. The composition block 254 updates the data in accordance with the composition information slot's requisite general configuration for all the tiles in the frame. For example, the configuration slot may indicate the priority for processing each update tile of the frame thread or the priority of processing a certain frame (frame thread) among multiple frame threads; the tile shape, being square, rectangular, octagon or another geometric shape and its height and width in pixels; and various other configuration parameters including internal color, cluster size, tile region size, display width and display height. The composition parameters are loaded or written into the composition block registers to direct the composition of a selected tile located at particular coordinates within an update rectangle or update frame. The specification of each tile is provided separately to each composition block 254, 256, 258, by the scheduling block 266. As the composition block updates or composes the selected tile, the composition block then loads the updated tile information into the tile FIFOs 264.

Tile FIFOs 264 may be memory locations internal to the display engine, but in some embodiments may be found in memory that is external memory. Each update tile is loaded into the tile FIFOs 264 as it is created by each composition block. Thus, the plurality of tile FIFOs hold update tiles created by the plurality of composition blocks 254, 256, 258 of the exemplary display engine 252 to create an entire update frame.

The scheduling block 260 provides instruction signals to the refresh block 262. These refresh instructions inform the refresh block 262 when to start extracting the update tiles from the tile FIFOs 264 and to start constructing the image frame using the extracted update tiles. The refresh block 262 also receives refresh slot information 270 from a refresh slot 122. The refresh slot instructions 270 further provide the refresh block with informational instructions about how to format the update tiles into an update frame to be provided and displayed via the display circuitry 104. In some embodiments, the refresh block may provide frame data back to a memory or other storage means for use at a later time. Such a storage means may be any magnetic, electromechanical or solid state memory device commonly used for storing video or other streaming or still graphic data.

Referring now to FIG. 4, another embodiment of a display engine 300 is depicted in order to further aid understanding of an exemplary display list mechanism that is used as an interface between a display engine driver and a scalable display engine configuration. FIG. 4 depicts an embodiment that utilizes three display lists being display list A 302, display list B 304 and display list C 306. The display lists may be stored in a portion of the display engine's internal memory. The exemplary display engine 300 comprises a scheduling block 308, three composition blocks 310, 312, and 314 and three refresh blocks 316, 318 and 320. There is also a plurality of tile FIFOs generally indicated as 322. The tile FIFOs 322 are divided, in this embodiment, into three tile FIFOs to support and provide update tiles to the plurality of refresh blocks. The plurality of refresh blocks 316, 318, 320 may each support a different display device being display device A 330, display device B 332 and display device C 334. Alternatively, each refresh block 316, 318, 320 may be set by a display list to support any of the display devices 330, 332, 334 (depending on which display device to which the refresh block is connected). The display engine 300 depicts a more complicated scenario than the display engines 102, 252 of FIGS. 2 and 3. Display engine 300 supports the execution of three graphic data threads (e.g., three source image frame data threads) simultaneously. In other words, display engine 300 can processes three frame threads in parallel. Each refresh block 316, 318, 320 may be connected to a specific display device or memory device 335. The composition blocks 310, 312, 314 can each process tiles from any of the three source image frame data threads and compose update tiles appropriate for an image frame for the designated display. The tile data is provided to the appropriate tile FIFO for the designated display output. The scheduler 308 is adapted to receive the slot information from all the display lists, 302, 304, 306 and schedule the composition jobs (i.e., process the update tiles) for the three graphic data threads according to the priority settings provided from the different display lists.

Display list A 302 provides the slot instructions used by the scheduling block 308 to schedule the composition blocks 310, 312, 314 and the first refresh block 316 to prepare an image frame appropriate for display A 330. Similarly, display list B 304 provides the scheduling block 308 the necessary slot instructions to schedule the composition blocks 310, 312, 314, as well as the second refresh block 318 to prepare an image frame appropriate for display B 332. Furthermore, display list C 306 provides slot instructions used by the scheduling block 308 to schedule the composition blocks 310, 312, 314 and the third refresh block 320 to prepare an image frame appropriate for display 334. Each composition block 310, 312, 314 acquires needed slot instructions from the appropriate display list 302, 304, 306 depending on the frame thread and display that the scheduling block 308 instructed the particular composition block to compose an update tile for.

Each time a new updated frame (i.e., update image frame) is to be produced by an exemplary display engine, aspects of the associated display lists are updated by the display engine driver or other software operating external to an exemplary display engine. If a tile is affected by more than one update rectangle then the scheduler may send or loop the same tile to a composition block for processing multiple times; once for each update rectangle that the tile is affected by. Further, via the caching mechanism incorporated by exemplary embodiments, if prior to composing an update tile for a particular update frame, a dirty bit(s) indicates that certain parameters have not changed with respect to the last frame, then cached data from the last frame can be reused in the current frame thereby saving time in not having to reload the certain parameters for use with the current frame. For example, a linearization table that was already loaded and used for a previous frame may not have to be reloaded for the current frame if the dirty bit indicates that the contents of the table has not changed. The cache memory may be a portion or part of the display engine's internal memory.

In some embodiments of the invention, an exemplary high-performance hardware display engine accelerator configuration that utilizes an exemplary display list mechanism, interface or software interface of the present invention is provided. Exemplary display engine hardware accelerator architecture is designed to be scalable in terms of processing pipeline replication and processing block feature dimensioning. This makes the resulting exemplary architecture both modular and scalable, so as to more easily address the needs and preferences required by different platforms or systems that incorporate a display engine. Exemplary display engine hardware may require less redesign or new design because of its ability to be modified based on its modular configuration of hardware processing blocks and its standardized display list interface that accepts display engine frame thread instructions from a display engine driver or other external software without requiring direct interaction with most, if not all, registers internal to the display engine architecture.

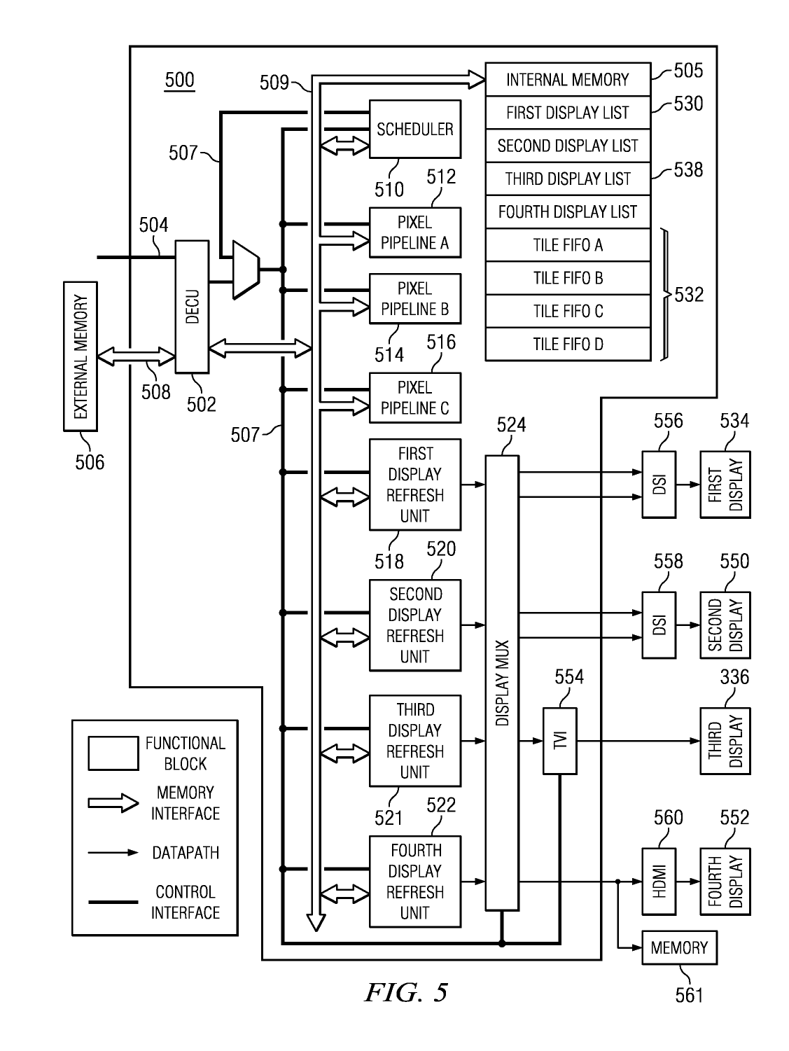

Exemplary modular and scalable display engine architecture 500 is shown in FIG. 5. The exemplary display engine 500 interfaces with one or more display engine driver(s) via multiple display lists, which are provided by the display engine driver (or other software) and stored in the internal memory 505. Each display engine processing block is responsible for processing or controlling aspects of frame data threads for each frame to be updated for display on a display device in accordance with slot instructions provided by an associated display list. Internally, the display engine 500 performs composition and refresh jobs on a tile basis. There are six basic processing blocks included in the exemplary display engine architecture. The processing blocks include a display engine control unit (DECU) block 502, which connects the display engine 500 with the rest of the platform or system to which the display engine is associated. The DECU 502 connects to an external control interface 504, which may connect to the platform's processor or coprocessor device. The DECU 502 receives instructions to load a next display list from external memory via the external control interface 504. The next display list is loaded into a portion of internal memory 505. The DECU 502 also connects to external memory 506 via a memory interface 508. The DECU 502 controls interaction with the memories and register accesses, as well as the clocks and the resets of the various display engine processing blocks. The DECU is connected to the various display engine processing blocks via an internal control interface or interfaces 507. The DECU 502 is also connected to the internal memory/register interface 509. The DECU 502 is typically the processing block that accepts display lists and source image data for frames that are to be updated by the exemplary display engine architecture 500.

A scheduler block 510 is connected to the internal control interface 507 as well as to the internal memory interface 509. The scheduler block 510 controls the execution flow of the composition and refresh jobs, via the internal control interface 507 and internal memory interface 509, according to the necessities of the slot instructions dictated by the display list for the particular frame and frame-tile. The scheduler 510 prioritizes processing of frames or frame threads and in some aspects, the priority of processing tiles for different frame threads according to the display list slot instructions, provided by the display engine driver. Each time a frame is refreshed for a selected display, the display engine driver may update or revise all or part of the display list for the next frame. The display engine driver may be run by an external microprocessor (not specifically shown) and communicates that a new display list for the next frame is ready to be read from external memory 506 via the external control interface 504 and the DECU 502. The DECU 502 may update a first display list 530 via the internal memory interface 509. As such, each display list operates as an interface means or mechanism between a display engine driver and the actual scalable, physical display engine architecture by containing and providing all the needed informational instructions or parameters required for processing a frame of source image data into an image frame. The display engine driver does not communicate directly with the registers or structural blocks of an exemplary display engine, but instead via an exemplary standardized display list interface or software interface.

The exemplary display engine 500 further comprises a plurality of pixel pipeline blocks 512, 514, 516. In this embodiment, three pixel pipeline blocks are used, but embodiments may comprise one or more pixel pipeline blocks that operate in parallel. Each pixel pipeline block, 512, 514, 516 is comparable to composition blocks shown in FIGS. 2, 3 and 4. A pixel pipeline block performs tile composition of portions of the frame image data to create update tiles that will ultimately be organized into an update or image frame. Each pixel pipeline block is not dedicated to a single frame thread, but instead can perform tile composition of update tiles for any frame thread that the scheduler sets it to process. Each pixel pipeline block will process an update tile according to the frame tread's display list slot instructions. The registers associated with a pixel pipeline block are configured by the scheduler in accordance with the tile and frame thread that the particular pixel pipeline block is constructing or updating. A pixel pipeline block may also, in accordance with the associated display list and register settings, provide transparent data feed-though wherein the pixel pipeline moves data for a particular tile from cache memory (not specifically shown) through the pixel pipeline block without changes because no changes may be necessary in the update tile or update tile portion of the next frame. Such transparent data feed-through may occur when a particular display list is instructed to be set as a static display list for two or more subsequent consecutive frames. A static display list does not have to be reloaded into memory for each subsequent source image data frame and therefore saves memory access time. A static display list may be used in a variety of situations such as for example: i. when a static image is to be displayed on the display, or ii. when subsequent source image data frames are either identical or are to be processed by the display engine in an identical manner as a previously processed source image data frame. Use of a static display list further minimizes memory update processes and increases image processing efficiency.

The scheduler 510 informs the pixel pipeline, for example, pixel pipeline 512, which tile FIFO A, B, C or D 532 is associated with the frame thread for which the update tile is being created. The proper associated tile FIFO memory A, B, C or D 532 receives pixel pipeline output data, in the form of an update tile, via the internal memory interface 509. As shown, the tile FIFO memory 532 may be divided into multiple tile FIFO sections A, B, C or D each having predetermined address locations so that each pixel pipeline 512, 514, 516 can each be working on different tiles for any of a plurality of frame threads being processed. For example, pixel pipeline A 512 may be creating a first update tile for a first image frame of a first display 534, while pixel pipeline B 514 is processing a second update tile for a second image frame designated for a third display 536. Meanwhile pixel pipeline C 516 is processing a third update tile, which is also for the first image frame for the first display 534. Although the tile FIFOs 532 are shown in the exemplary display engine 500 as being part of the internal memory 505, other embodiments may use an external memory such as external memory 506 to store the tile FIFOs.

Each pixel pipeline 512, 514, 516 is connected to the scheduler 510 in the DECU 502 via the internal control interface 507. Each pixel pipeline block will be presented the same display list slot information when preparing an update tile for a same frame thread that will be displayed on a same display. For example, if the first display list 530 provides slot information for a particular frame to be displayed on the first display 534, then whenever pixel pipeline A 512 is processing an update tile for a frame thread for the first display 534, the scheduler 510 will provide to or indicate where in memory/registers that pixel pipeline 512 should acquire first display list related parameters or instructional information needed to process an update tile destined for the first display 534. Pixel pipeline A 512 may also get proper instructional information parameters directly from the first display list via the internal memory interface 509. Conversely, if pixel pipeline A 512 is being instructed by the scheduler 510 to configure an update tile for a frame thread for display on the third display 336, the scheduler 510 will provide to or indicate where in memory/registers that pixel pipeline 512 should acquire third display list related parameters or instructional information needed to process an update tile destined for the third display 336. Pixel pipeline A 512 may also get proper instructional information parameters directly from the third display list via the internal memory interface 509.

When composing a frame, the scheduler block 510 divides the display area (determined by the width and height parameters found in the configuration slot) into tiles. Then for each update rectangle area in the display area, the scheduler block 510 determines which tiles are affected (i.e., intersected) by an update rectangle area. The affected tiles are sent to be composed by the pixel pipeline blocks 512, 514, 516 into update tiles. This process is performed without taking into account whether any of the affected tiles also have an input layer affecting them. The pixel pipeline blocks 512, 514, 516 each look through the input layer(s) associated with the particular frame thread being processed and determines whether any part of an input layer should be used in composing the tile being processed by the particular pixel pipeline block. This methodology speeds up the processing of image frames as several tiles may be independently processed and composed by different pixel pipeline blocks 512, 514, 516 in parallel. Furthermore, when an update tile is output from a pixel pipeline block, the update tile is ready to be sent out to a display, which when compared to processing tiles in a layer-by-layer fashion, requires much less memory storage space. The result being that the on-board memory storage requirement for update tiles does not need to be substantially larger than the amount of memory required to store all the update tiles for one image frame per frame thread that is being processed. In additional embodiments, the on-board memory storage requirement for update tiles does not need to store all the update tiles for one image frame, but instead some completed tiles may be sent to the display while others are being composed in the display engine. In such an embodiment, the on-board memory size requirement will depend on the update tile composition speed and the refresh frequency required by the display device.

The exemplary display engine 500 further comprises four display refresh units 518, 520, 521, 522. Each display refresh unit is a processing block that executes frame refresh jobs for a frame thread designated by the scheduler 510. A frame refresh job comprises refreshing designated tiles of a designated frame with update tiles organized as an update frame or image frame so that the image frame will be provided for display in accordance with requirements of a particular display device. To perform a frame refresh job a first display refresh unit 518 will be instructed by the scheduler 510 which display parameters (extracted from the appropriate display list and from the appropriate registers) to use along with the beginning address of the tile FIFO where the update tiles (the update tile pixel information) for the frame to be updated is located. The display refresh unit then accepts update tiles from the indicated tile FIFO, organizes the update tiles for output of an image frame update for the specific frame to the display MUX 524. The display MUX 524 is then switched in accordance to instructions from the scheduler 510 to provide the update frame output to the appropriate interface electronics so that the image frame update can be provided to the proper display device. The display MUX 524 controls the connections between the plurality of the display units 518, 520, 521, 522 and the output displays 534, 550, 336, 552 or memory 561. Thus, each display refresh unit may refresh frames for any graphic thread in accordance with the display list instructions for the particular frame of the graphic thread. Each display refresh unit is not made specifically to interface with one display output, but instead may provide image frame update outputs for different threads designated for different display devices.

In this embodiment, a TV out interface (TVI) 554 interfaces the display MUX 524 with a television style display or third display 336. The TVI may be an analog TV-out encoder or a reasonable facsimile thereof. The TVI 554 may be either integrated as part of the display engine device or may be an external circuit. In this exemplary embodiment, the display MUX 524 may be connected to provide image frame update data to a first display serial interface (DSI) 556 and to a second DSI 558. The display MUX 524 further may provide image frame update data output to a high definition multi-media interface (HDMI) circuit 560, which may be connected to a fourth display device 552 that is a high definition display screen. Furthermore, the MUX 524 may provide updated frame data output to a memory or storage device 561 for storage and perhaps display at a later time.

As such, FIG. 5 depicts an architectural overview of an exemplary display engine. To summarize, this exemplary display engine 500 includes one DECU block 502, one scheduler block 510, three pixel pipeline blocks 512, 514, 516, four display refresh unit blocks 518, 520, 521, 522, one display MUX 524 and one analog TV out encoder 554. This exemplary display engine 500 offers support for eight simultaneous graphic or frame execution threads, four of which can send image frame update data to display devices of various types including two DSI display devices 556, 558, one TVI display device 336 and one HDMI based display circuit 560. The other four simultaneous graphic or frame threads support memory-to-memory composition operations where the tile data of one or more frame threads are being composed and processed into update tiles and stored in appropriate FIFOs in accordance with associated display list interface slot instructions.

An exemplary embodiment is clearly scalable and may be comprised of one or more pixel pipeline blocks and one or more display refresh blocks, such that each block may process the same or different frame thread tiles into update tiles and update image frames in parallel. Furthermore, each processing block may process consecutive or interleaved portions of a frame thread in accordance with priority instructions from one or more display lists that have been interpreted by the scheduler block.

The exemplary implementations for a display list mechanism, interface or software between a display engine driver (or other software) and a scalable display engine will now be described. The outcome of a display engine executing a display list is typically the generation of an image frame. The display list may be a list of instructions or parameters written to memory, from the display engine driver, to be executed by a display engine sequentially. Each instruction of the display list is referred to as a slot. The general types of slots are synchronization slots, configuration slots, frame update slots, composition slots, refresh slots, and memory management slots.

Synchronization slots are used to control the display list flow. Synchronization slots control the timing of the display list execution. They allow synchronization of both internal events and with external events and, in some embodiments, may connect or associate several display lists to each other. Synchronization slots are generally utilized by the scheduler block of an exemplary display engine.

Configuration slots are used to pass frame configuration instructional information, which remains constant during the execution of the entire display list associated with a particular frame. Configuration slots also contain parameters that need to be held in display engine registers for use by multiple processing blocks of an exemplary display engine. Configuration slots include general information that is not necessarily related to or specific to one particular frame. An exemplary configuration slot may contain a priority parameter. The intention of incorporating a priority parameter is to offer the software or display engine driver a means for informing the display engine about the importance of a particular display list job over or with respect to another display list job being parallel processed by the display engine. The other display list job may be for the same frame data thread or a different frame data thread that is being parallel processed by an exemplary display engine embodiment.

Frame update slots contain information about the regions or update rectangles that ought to be updated in the frame on the display and/or in memory. Frame update slots also may contain informational instructions for updating frame regions or update rectangles. Frame update slots may contain parameters that indicate whether image frame data or data structures (e.g., coefficient tables) can be reread from memory (cache) or if a dirty bit is set to indicate that the cached image frame data will be different in the next update tile or frame and must be updated and processed by a composition block or pixel pipeline prior to it being written to a tile FIFO.

Composition slots contain various types of informational instructions that are related to how each frame should be composed. For example, composition slots may prescribe where the positions of the input layers on the frame are, the resizing and blending of the input layers and color options. There can be various types of composition slots. For example, there may be a composition information slot, which provides composition information for an update area or update rectangle within the frame. There may be a source information slot, which instructs or provides the memory locations of where the data for each layer used in composition is located. Source information slots may further indicate the layer buffer properties. Another type of a composition slot is a format information slot. There may be a format information slot for each layer of image data to be used in a composition. A format information slot will contain all the properties related to color formatting of the layer. Additionally, there may be a composition slot that is referred to as an element information slot. There may be one element information slot for each layer. An element information slot may contain information about how to treat the layer buffer during composition of the tiles within an update area or update rectangle.

Refresh slots may contain the display or frame refresh informational instructions associated with a particular image frame update. Refresh slots prescribe how the composed image frame data should be transferred to the display. Refresh slots may provide color formats, color format indications, command insertions, statistical generation as well as memory output instructions. A type of refresh slot called a send command slot is used to send command instructions to the display interface block circuitry before and after each update frame.

Memory management slots prescribe data transfers (e.g., source image data, image frame(s), table data, parameter data, or substantially any type of image processing related data) between memory and the display engine. Memory management slot eliminate a need for software, display engine drivers or external processors to be interrupted to spend time on moving data in and out of memory associated with frame creation by a display engine. Memory management slots help to reduce the needed size of the internal memory on display engine integrated circuits. Memory management slots or memory copy slots tell the display engine hardware to copy data from external memory into internal memory or vice versa. The memory management slots may also prescribe the addresses and data length of the image data to be copied or moved.

In general, information needed by more than one functional circuit block of an exemplary display engine is passed to registers in the display engine in accordance with configuration slot instructions or parameters. Meanwhile, the scheduling block is responsible for passing the informational instructions, like tile size or frame size, via registers to make such informational instructions available to more than one processing block.

During execution of an exemplary display list interface the synchronization slots, configuration slots and memory copy slots should be utilized by a display engine synchronously. These slots should be completely performed by a display engine before a next slot in the display list is executed. Conversely, a send command slot or update slot may be read asynchronously with a next slot, because there is no necessity to wait until either of these two types of slots are completed prior to reading a next slot of the display list.

An exemplary display list interface or a mechanism may have its slots organized in the following manner:

There may be any number of synchronization slots in a display list. There is no requirement to have synchronization slots at the beginning or at the end of a display list.

There must be at least one configuration slot per display list. The first configuration slot in a display list must be located in the display list before the first frame update slot. The first configuration slot must come before the first update slot because the configuration slot contains general settings needed to correctly execute any update slot instructions. If there is more than one configuration slot in a display list, then more than one frame may be produced by one display list.

There may be any number of memory management or memory copy slots located in any position in a display list.

There may be any number of send command slots at any position in a display list.

There may be any number of frame update slots in a display list. Update slots use parameters to point to two regions in the display list memory that contain composition slots and refresh slots respectively. These regions of display list memory are not necessarily exclusive to one particular frame update, but instead the same regions in a display list memory may be pointed to by several update slots at the same time (because several pixel pipeline blocks may be parallel processing tiles of the same frame). Remember, update slots can be executed asynchronously, thus multiple update slots may point to a same memory location at the same time.

The composition slot region of display list memory that is pointed to by an update slot should be a configuration information slot. A configuration information slot will specify the number of layers that are to be used for this update and will further comprise a first pointer that points to a source information slot, a second pointer that points to a format information slot and a third pointer that points to an element information slot for each of the layers. These slots can be shared between several layers. For example, two slots can point to the same source information slot.

There should be one refresh information slot pointed to by each update slot.

Each slot of a display list will have a header and a list of parameters. The header is used as an identification code to identify the slot so hardware can find it. The length of each type of slot should be constant and byte or word aligned, for example, 32 bit aligned. Some of the exemplary slots might have empty or reserved areas so as to align the information in the slot and/or to provide room for future updates or changes to the slot. Some of the exemplary slots may have optional parameters. The length of the different types of slots may vary, and for example do not have to all be 32 bit aligned, but instead can be any standardized number of bits such as 8, 16, 32 or 64 bits.

In some embodiments, the display list is stored in external memory 506 or off chip memory. In other embodiments, the display list may be stored in a portion of internal memory, for example, on the display engine chip or integrated circuit. A display engine driver may utilize the memory copy slots to copy display list data into internal memory locations dynamically.

Exemplary display list slots may have a variety of standardized constructions. All slots will have a header portion to identify the slot. After the header, each slot may contain a list of parameters comprising the instructional information (i.e., the parameters) carried by the slot and associated with the frame data to be updated by the display engine. The following are examples of the parameters and a potential construction of various types of slots.

### 1. Synchronization Slot

Total size of a synchronization slot: 8 bytes

### SYNC Slot Structure

| Parameter | Data type | Comment | | |
|---|---|---|---|---|
| Header | 8 bits | 0x10 | | |
| | | Type name | Code | Description |
| Type | 3 bits | Wait_for_Irq | 0x00 | Wait for an external event specified by the |
| | (ENUM) | | | parameter Number to occur |
| | | Wait_for_Event | 0x01 | Wait for the USER_EVENT bit indicated by |
| | | | | Number to be set |
| | | Set_Event | 0x02 | Set user event bit Number immediately |
| | | Reset_Event | 0x03 | Reset user event bit Number immediately |
| | | Set_Event_Delayed | 0x04 | Set user event bit Number after a delay of |
| | | | | Delay Time clock cycles (delayed interrupt) |
| | | Reset_Event_Delayed | 0x05 | Reset user event bit Number after a delay of |
| | | | | Delay Time clock cycles (delayed interrupt) |
| | | User_Irq | 0x06 | It triggers the USER_IRQ for the thread |
| | | | | executing this Display List (DL). The User |
| | | | | IRQ Data (parameter below) will then be |
| | | | | used |
| | | Kill_DL | 0x07 | Kills the current DL and ignores the rest of |
| | | | | the display list (SW can use this so that only |
| | | | | a part of a Display List is executed). |

| | | |
|---|---|---|
| Number | 5 bits | It contains the IRQ number or User Event bit to be used with the wait |
| | | and trigger subtypes |
| Reserved 0 | 16 bits | Empty space to align slot |
| Delay Time | 16 bits | Delay time in clock cycles |
| User Irq | 16 bits | User supplied data to identify a user interrupt. This field may contain |
| Data | | the data that is copied to a marker register of the thread executing this |
| | | DL when the user IRQ occurs to let SW indentify it. |

### 2. Configuration Slot

Total size of a configuration slot: 12 bytes

### Configuration Slot Structure

| Parameter | Data type | Comment | | |
|---|---|---|---|---|
| Header | 8 bits | 0x20 | | |
| Priority | 3 bits | Priority of this Display List compared to the other DLs. 0x0 is the | | |
| | | lowest priority and 0x7 is the highest. | | |
| | | Name | Code | Description |
| Tile shape | 2 bits | 1024x1 | 0x00 | Width × Height (in pixels) |
| | (ENUM) | 32x32 | 0x01 | |
| | | 64x16 | 0x02 | |
| | | 128x8 | 0x03 | |

| | | Name | Code |
|---|---|---|---|
| Internal | 3 bits | ARGB8888 | 0x0 |
| color format | (ENUM) | RGB888 | 0x1 |
| | | RGB565 | 0x2 |
| | | RGB666 | 0x3 |
| | | RGB10_10_10 | 0x4 |
| | | YUV422 | 0x5 |
| | | YUV444 | 0x6 |
| | | YUV444_10BITS | 0x7 |

| | | |
|---|---|---|
| B2R cluster | 8 bits | Number of tiles which needs to be sent together to the refresh block. |
| size | | Minimum value is 0x01 (in case of single buffer B2R, this value |
| | | should be 1) |
| Tile region | 8 bits | Maximum number of tiles that can fit in the tile region. It should be a |
| size | | multiple of the B2R cluster size (at least 2 times the cluster size) |
| Display | 13 bits | Horizontal resolution of the display in pixels |
| width | | |
| Reserved_0 | 3 bits | Empty space to align slot |
| Display | 13 bits | Vertical resolution of the display in pixels |
| height | | |
| Reserved_1 | 3 bits | Empty space to align slot |
| Tile region | 20 bits | 64-bit word aligned byte address of the region in internal memory |
| gptr | | where tiles produced while executing this DL should be stored |
| Reserved_2 | 4 bits | Empty space to align slot |
| Partition | 8 bits | Number of consecutive tiles which should be allocated to the same |
| width | | composition block. (Only used when the horizontal crown reuse for the |
| | | UPDATE slot being executed is ON) |

### 3. Memory Slot

Total size of a memory slot: 12 bytes

### Memory Slot Structure

| Parameter | Data type | Comment | | |
|---|---|---|---|---|
| Header | 8 bits | 0x30 | | |
| Data | 1 bit | 0x0 | MMU_TABLE | |
| Content | | 0x1 | OTHER_DATA | |
| Direction | 1 bit | 0x0 | EXTERNAL_TO_INTERNAL | |
| | | 0x1 | INTERNAL_TO_EXTERNAL | |
| | | Name | Code | Description |
| External | 2 bits | NONE | 0x0 | No L2 cache nor virtual |
| memory | | | | memory |
| source | | L2 | 0x1 | Use L2 cache |
| select | | VM | 0x2 | Virtual memory enable |
| | | L2_VM | 0x3 | L2 cache + virtual mem |

| | | |
|---|---|---|
| Reserved_0 | 4 bits | Empty space to align slot |
| Length | 16 bits | Size (in bytes) of the region to be copied |
| External | 32 bits | External memory byte address from where to fetch/where to write |
| mem. | | the data |
| Address | | |
| Internal | 20 bits | 64-bit word aligned byte address where to write/from where to fetch |
| mem. | | the data |
| Address | | |
| Reserved_1 | 12 bits | Empty space to align slot |

### 4. Send Command Slot

Total size of a send command slot: 8 bytes

### Send Command Slot Structure

| Parameter | Data type | Comment |
|---|---|---|
| Header | 8 bits | 0x40 |
| Reserved_0 | 8 bits | Empty space to align slot |
| Length | 16 bits | Size of the cmd buffer (in bytes) |
| Cmd buffer | 20 bits | 64-bit word aligned byte address of the region in internal memory |
| gptr. | | where the command buffer starts |
| Reserved_1 | 12 bits | Empty space to align slot |

### 5. Update Slot

Total size of an update slot: 12+Number of update rectangles*12 bytes

| Parameter | Data type | Comment | |
|---|---|---|---|
| Header | 8 bits | 0x50 | |
| Number of | 8 bits | Number of update rectangles to be passed at the end of the slot which | |
| update | | will update the current update. A value 0 will indicate a full display | |
| rectangles | | update. In that case, there won't be any update rectangle parameters, | |
| | | but there will be 1 SW cmd list external memory pointer. | |
| Delin. table | 1 bit | Related to the Delinearization table | One of these bits set |
| dirty bit | | | to 0x1 will indicate |
| Resize filter | 1 bit | Related to the Resize Filter X table | that the content of |
| X table dirty | | | the table has |
| bit | | | changed even |
| Resize filter | 1 bit | Related to the Resize Filter Y table | though the location |
| Y table dirty | | | in memory is the |
| bit | | | same. |
| First color | 1 bit | Related to the First Color conversion table | |
| conv. table | | | |
| dirty bit | | | |
| Lin. table | 1 bit | Related to the Linearization table | |
| dirty bit | | | |
| Second | 1 bit | Related to the Second Color conversion table | |
| color conv. | | | |
| table dirty | | | |
| bit | | | |

| | | | |
|---|---|---|---|
| Horizontal | 1 bit | 0x0 | OFF |
| Crown reuse | | 0x1 | ON |
| Vertical | 1 bit | 0x0 | OFF |
| Crown reuse | | 0x1 | ON |

| | | |
|---|---|---|
| Reserved_1 | 8 bits | Empty space to align slot |
| Composition | 20 bits | 64-bit word aligned byte address in internal memory of the |
| list gptr. | | COMP_INFO slot. |
| Reserved_2 | 12 bits | Empty space to align slot |
| Refresh list | 20 bits | 64-bit word aligned byte address in internal memory of the |
| gptr. | | REFRESH_INFO slot. |
| Reserved_3 | 12 bits | Empty space to align slot |
| SW cmd list | 32 bits | Byte address pointer to the SW generated tile command list in external |
| N external | | memory for the region N*. The source select setting and stride for this |
| memory | | buffer will be included in the REFRESH_INFO slot and are common |
| pointer | | for all regions of the same UPDATE slot. |
| Update | 12 bits | Left-most pixel coordinate of the rectangle number N to be updated*. |
| Rect. N left | | It must be smaller than the display width. |
| Reserved_4 | 4 bits | Empty space to align slot |
| Update | 12 bits | Right-most pixel coordinate of the rectangle number N to be updated* |
| Rect. N | | (left <= right). It must be smaller than the display width. |
| right | | |
| Reserved_5 | 4 bits | Empty space to align slot |
| Update | 12 bits | Top-most pixel coordinate of the rectangle number N to be updated. It |
| Rect. N top | | must be smaller than the display height. |
| Update | 12 bits | Bottom-most pixel coordinate of the rectangle number N to be updated |
| Rect. N | | (top <= bottom). It must be smaller than the display height. |
| bottom | | |
| Reserved_7 | 4 bits | Empty space to align slot |

### 6. Composition Information Slot

Total size of a composition information command slot: 32+Number of input layers 8 bytes

### Computer Information Slot Structure

| Parameter | Data type | Comment | | |
|---|---|---|---|---|
| Header | 8 bits | 0x60 | | |
| Number of | 8 bits | Number of layers to be processed. | | |
| input layers | | | | |
| YUV422 | 1 bit | When internal color format is YUV422, this parameter indicates | | |
| Chroma | | how the chromas should be sampled | | |
| Sampling | | 0x0 | | Chroma Co-sited |
| | | 0x1 | | Chroma interpolated |
| Second color | 1 bit | 0x0 | OFF | No second color conv. Applied |
| conversion | | 0x1 | ON | Apply second color conv. |
| mode | | | | |

| | | Name | Code | Description |
|---|---|---|---|---|
| Delinearization | 2 bits | DISABLE | 0x0 | Disable |
| mode | (ENUM) | FUNCTION | 0x1 | Enable - use a fixed function |
| | | TABLE | 0x2 | Enable - use a table |
| OLED | 1 bit | 0x0 | DISABLE | If OLED correction is enabled the |
| correction | | 0x1 | ENABLE | internal color format must be in |
| | | | | RGB color space. |

| | | |
|---|---|---|
| Reserved_0 | 11 bits | Empty space to align slot |
| R_Y low value | 12 bits | Lowest value allowed for the R or Y components in the pixels |
| 1 | | after second color conversion sub-block. (Only used if second |
| | | color conversion mode is ON) |
| Reserved_1 | 4 bits | Empty space to align slot |
| R_Y high value | 12 bits | Highest value allowed for the R or Y components in the pixels |
| 1 | | after second color conversion sub-block. (Only used if second |
| | | color conversion mode is ON) |
| Reserved_2 | 4 bits | Empty space to align slot |
| G_U low value | 12 bits | Lowest value allowed for the G or U components in pixels after |
| 1 | | second color conversion sub-block. (Only used if second color |
| | | conversion mode is ON) |
| Reserved_3 | 4 bits | Empty space to align slot |
| G_U high value | 12 bits | Highest value allowed for the G or U components in pixels after |
| 1 | | second color conversion sub-block. (Only used if second color |
| | | conversion mode is ON) |
| Reserved_4 | 4 bits | Empty space to align slot |
| B_V low value | 12 bits | Lowest value allowed for the B or V components in pixels after |
| 1 | | second color conversion sub-block. (Only used if second color |
| | | conversion mode is ON) |
| Reserved_5 | 4 bits | Empty space to align slot |
| B_V high value | 12 bits | Highest value allowed for the B or V components in pixels after |
| 1 | | second color conversion sub-block. (Only used if second color |
| | | conversion mode is ON) |
| Reserved_6 | 4 bits | Empty space to align slot |
| Background | 32 bits | Constant color of the background in ARGB8888 format |
| color | | |
| Delinearization | 20 bits | 64-bit word aligned byte address of the delinearization table in |
| gptr. | | internal memory to use when delinearization_mode = TABLE. for |
| | | details on how the coefficients are organized in memory. (Only |
| | | used if second color conversion mode is ON) |
| Reserved_7 | 12 bits | Empty space to align slot |
| Second color | 20 bits | 64-bit word aligned byte address in internal memory of the table |
| conversion gptr. | | to use for the second color conversion. for details on how the |
| | | coefficients are organized in memory. |
| Reserved_8 | 44 bits | Empty space to align slot |
| Source info gptr | 20 bits | 64-bit word aligned byte address in internal mem of |
| | | SOURCE_INFO slot |
| Format info | 20 bits | 64-bit word aligned byte address in internal mem of |
| gptr | | FORMAT_INFO slot |
| Element info | 20 bits | 64-bit word aligned byte address in internal mem of |
| gptr | | ELEMENT_INFO slot |
| Reserved_9 | 4 bits | Empty space to align slot |

### 7. Source Information Slot

Total size of a source information slot: 32 bytes

### Source Information Slot Structure

| Parameter | Data type | Comment | | |
|---|---|---|---|---|
| Header | 8 bits | 0x70 | | |
| Reserved_0 | 24 bits | Empty space to align slot | | |
| Layer width | 13 bits | Width in pixels of the layer | | |
| Reserved_1 | 3 bits | Empty space to align slot | | |
| Layer height | 13 bits | Height in pixels of the layer | | |
| Reserved_2 | 3 bits | Empty space to align slot | | |
| | | Name | Code | Description |
| Input Layer | 2 bits | NONE | 0x0 | No L2 cache nor virtual memory |
| external | | L2 | 0x1 | Use L2 cache |
| memory | | VM | 0x2 | Virtual memory enable |
| source | | L2_VM | 0x3 | L2 cache + virtual mem |
| select | | | | |
| Destination | 2 bits | NONE | 0x0 | No L2 cache nor virtual memory |
| alpha mask | | L2 | 0x1 | Use L2 cache |
| external | | VM | 0x2 | Virtual memory enable |
| memory | | L2_VM | 0x3 | L2 cache + virtual mem |
| source | | | | |
| select | | | | |
| Dest. Alpha | 2 bits | OFF | 0x0 | No separate dest. alpha mask buffer |
| mask format | (ENUM) | 1BIT | 0x1 | Alpha mask of 1 bpp |
| | | 8BIT | 0x2 | Alpha mask of 8 bpp |

| | | |
|---|---|---|
| Reserved_3 | 10 bits | Empty space to align slot |
| Dest. Alpha | 16 bits | Stride of the destination alpha mask buffer in number of bytes (only |
| mask stride | | used if dest. alpha mask format = 1BIT or 8BIT) |
| Layer | 32 bits | Address in external memory of the layer buffer data (in case of |
| pointer | | separate YUV formats, the pointer to the buffer with the Y |
| | | components) |
| Layer U | 32 bits | When using YUV separate formats, pointer to the external memory |
| pointer | | buffer with the UV components (if 2-planed) or U components (3- |
| | | planed) |
| Layer V | 32 bits | When using YUV 3-planed formats, pointer to the external memory |
| pointer | | buffer with the V components |
| Layer stride | 16 bits | Stride of the layer buffer in number of bytes (in case of separate |
| | | YUV formats, the stride of the buffer with the Y components) |
| Layer U/V | 16 bits | When using YUV separate formats, stride to use for buffer(s) |
| stride | | containing the U and V components in number of bytes. |
| Destination | 32 bits | Address in external memory of the destination alpha mask buffer to |
| alpha mask | | be used in some blending functions (only used if dest. alpha mask |
| pointer | | format = 1BIT or 8BIT) |

### 8. Format Information Slot

Total size of a format information slot: 24 bytes

### Format Information Slot Structure

| Parameter | Data type | Comment | | |
|---|---|---|---|---|
| Header | 8 bits | 0x80 | | |
| | | Name | | Code |
| Layer Color | 4 bits | ARGB8888 | | 0x0 |
| Format | (ENUM) | ARGB4444 | | 0x1 |
| | | ARGB1555 | | 0x2 |
| | | RGB888 | | 0x3 |
| | | RGB565 | | 0x4 |
| | | RGB10_10_10 | | 0x5 |
| | | A8 | | 0x6 |
| | | L8 | | 0x7 |
| | | BW1 | | 0x8 |
| | | YUV422_INT | | 0x9 |
| | | YUV420_3_PLANED | | 0xA |
| | | YUV420_2_PLANED | | 0xB |
| | | YUV420_MB | | 0xC |
| | | YUV444_INT | | 0xD |
| | | YUV444_10BITS | | 0xE |
| Color | 1 bit | 0x0 | | Input color not premultiplied |
| premultiplied | | 0x1 | | Input color premultiplied |
| YUV420 | 1 bit | When layer color format is YUV420, this parameter indicates how | | |
| Input mode | | the data has been sampled | | |
| | | 0x0 | Chroma Co-sited | |
| | | 0x1 | Chroma interpolated | |
| First color | 1 bit | 0x0 | OFF | No first color conv. Applied |
| conversion | | 0x1 | ON | Apply first color conv. |
| mode | | | | |

| Reserved_0 | 1 bits | Empty space to align slot | | |
|---|---|---|---|---|
| R_Y low value | 12 bits | Lowest value allowed for the Y or R components in the pixels after | | |
| 0 | | first color conversion sub-block. (Only used if first color conversion | | |
| | | mode is ON) | | |
| Reserved_1 | 4 bits | Empty space to align slot | | |
| R_Y high | 12 bits | Highest value allowed for the Y or R component in the pixels after | | |
| value 0 | | first color conversion sub-block. (Only used if first color conversion | | |
| | | mode is ON) | | |
| Reserved_2 | 4 bits | Empty space to align slot | | |
| G_U low | 12 bits | Lowest value allowed for the U or G components in the pixels after | | |
| value 0 | | first color conversion sub-block. (Only used if first color conversion | | |
| | | mode is ON) | | |
| Reserved_3 | 4 bits | Empty space to align slot | | |
| G_U high | 12 bits | Highest value allowed for the U or G components in the pixels after | | |
| value 0 | | first color conversion sub-block. (Only used if first color conversion | | |
| | | mode is ON) | | |
| Reserved_4 | 4 bits | Empty space to align slot | | |
| B_V low value | 12 bits | Lowest value allowed for the V or B components in the pixels after | | |
| 0 | | first color conversion sub-block. (Only used if first color conversion | | |
| | | mode is ON) | | |
| Reserved_5 | 4 bits | Empty space to align slot | | |
| B_V high | 12 bits | Highest value allowed for the V or B components in the pixels after | | |
| value 0 | | first color conversion sub-block. (Only used if first color conversion | | |
| | | mode is ON) | | |
| Reserved_6 | 4 bits | Empty space to align slot | | |
| Comp 0 pos | 2 bits | Position of the color components in the input layer. (Applies to RGB | | |
| Comp 1 pos | 2 bits | & YUV formats). | | |
| Comp 2 pos | 2 bits | | | |
| Comp 3 pos | 2 bits | | | |
| | | Name | Code | Description |
| Linearization | 2 bits | DISABLE | 0x0 | Disable |
| mode | (ENUM) | FUNCTION | 0x1 | Enable - use fixed function |
| | | TABLE | 0x2 | Enable - use table |

| | | |
|---|---|---|
| Reserved_7 | 6 bits | Empty space to align slot |
| First color | 20 bits | 64-bit word aligned byte address in internal memory of the table to |
| conversion | | use for the first color conversion. (Only used if first color |
| gptr | | conversion mode is ON) |
| Reserved_8 | 12 bits | Empty space to align slot |
| Linearization | 20 bits | 64-bit word aligned byte address in internal memory of the |
| gptr | | linearization table to use when linearization mode = TABLE. |
| Reserved_9 | 12 bits | Empty space to align slot |

### 9. Element Information Slot

Total size of an element information slot: 48 bytes

### Element Information Slot Structure

| Parameter | Data type | Comment | | |
|---|---|---|---|---|
| Header | 8 bits | 0x90 | | |
| | | Name | Code | |
| Scale | 2 bits | 1_TAP | 0x0 | |
| quality X | | 2_TAPS | 0x1 | |
| | | 5_TAPS | 0x2 | |
| | | 8_TAPS | 0x3 | |
| Scale | 2 bits | 1_TAP | 0x0 | |
| quality Y | | 2_TAPS | 0x1 | |
| | | 5_TAPS | 0x2 | |
| | | 8_TAPS | 0x3 | |
| Horizontal | 1 bit | 0x0 | OFF | |
| Crown reuse | | 0x1 | ON | |
| Vertical | 1 bit | 0x0 | OFF | |
| Crown reuse | | 0x1 | ON | |
| Resize | 1 bit | 0x0 | OFF | No resize is performed |
| mode | | 0x1 | ON | Resize according to step & offset |
| | | | | param. |
| Reserved_0 | 17 bits | Empty space to align slot | | |
| Dest. Rect. | 14 bits | Signed inclusive left-most pixel coordinate of the destination | | |
| left | | rectangle. It must be smaller than the display width. | | |
| Reserved_1 | 2 bits | Empty space to align slot | | |
| Dest. Rect. | 14 bits | Signed inclusive right-most pixel coordinate of the destination | | |
| right | | rectangle (it is not necessary that it is smaller than the display | | |
| | | width). Left <= right. | | |
| Reserved_2 | 2 bits | Empty space to align slot | | |
| Dest. Rect. | 14 bits | Signed inclusive top-most pixel coordinate of the destination | | |
| top | | rectangle. It must be smaller than the display height. | | |
| Reserved_3 | 2 bits | Empty space to align slot | | |
| Dest. Rect. | 14 bits | Signed inclusive bottom-most pixel coordinate of the destination | | |
| bottom | | rectangle (it is not necessary that it is smaller than the display | | |
| | | height). Top <= bottom. | | |
| Reserved_4 | 2 bits | Empty space to align slot | | |
| Src Step X | 16 bits | Relation between the original width of the layer and the final one. | | |
| | (8.8) | The value contains 8 bits integer part and 8 bits fractional part | | |
| | | (value >1.0 scale down, value <1.0 scale up). Only used if resize | | |
| | | mode is ON | | |
| Src Step Y | 16 bits | Relation between the original height of the layer and the final one. | | |
| | (8.8) | The value contains 8 bits integer part and 8 bits fractional part | | |
| | | (value >1.0 scale down, value <1.0 scale up). Only used if resize | | |
| | | mode is ON | | |
| Src Offset X | 21 bits | Distance in the horizontal direction of the upper left corner of the | | |
| | (13.8) | source rectangle respect the layer origin. The value contains 13 | | |
| | | bits integer part and 8 bits fractional part. If resize mode is OFF | | |
| | | only the integer part is used. | | |
| Reserved_5 | 11 bits | Empty space to align slot | | |
| Src Offset Y | 21 bits | Distance in the vertical direction of the upper left corner of the | | |
| | (13.8) | source rectangle respect the layer origin. The value contains 13 | | |
| | | bits integer part and 8 bits fractional part. If resize mode is OFF | | |
| | | only the integer part is used. | | |
| Reserved_6 | 11 bits | Empty space to align slot | | |
| Resize filter | 20 bits | 64-bit word aligned byte address of the resize filter X table (only | | |
| X gptr. | | used for some scale qualities) | | |
| Reserved_7 | 12 bits | Empty space to align slot | | |
| Resize filter | 20 bits | 64-bit word aligned byte address of the resize filter Y table (only | | |
| Y gptr. | | used for some scale qualities) | | |
| Reserved_8 | 12 bits | Empty space to align slot | | |
| Inter-tile | 20 bits | 64-bit word aligned byte address of the memory area where the | | |
| gptr. | | inter-tile data of this layer should be placed (only used if | | |
| | | horizontal_crown_reuse = ON) | | |
| Reserved_9 | 12 bits | Empty space to align slot | | |
| Inter- | 20 bits | 64-bit word aligned byte address of the memory area where the | | |
| scanline | | inter-scanline data of this layer should be placed (only used if | | |
| gptr. | | vertical_crown_reuse = ON) | | |
| Reserved_10 | 12 bits | Empty space to align slot | | |
| Transparent | 30 bits | Transparent color in RGB10-10-10 format (R the LSB and B the | | |
| source color | | MSB) to be used in some blending functions (only used if | | |
| | | transparent color enable = ENABLE) | | |
| Transparent | 1 bit | 0x0 | DISABLE | |
| color enable | | 0x1 | ENABLE | |
| Reserved_11 | 1 bit | Empty space to align slot | | |
| Global | 8 bits | Constant global alpha to be used in some blending functions | | |
| Alpha | | | | |
| | | Name | Code | Description |
| Rotation | 3 bits | NONE | 000 | The lower bit of this |
| | (ENUM) | FLIP | 001 | parameter will indicate flip, |
| | | MIRROR | 010 | the middle one mirror and the |
| | | FLIP_MIRROR | 011 | upper direction. Combining |
| | | ROTATE | 100 | these bits we get all the |
| | | ROTATE_FLIP | 101 | possible positions of an image |
| | | ROTATE_MIRROR | 110 | |
| | | ROTATE_FLIP_MIRROR | 111 | |
| Reserved_12 | 5 bits | Empty space to align slot | | |
| Blending | 3 bits | NONE | 000 | The lower bit indicates the |
| function | (ENUM) | GLOBAL | 001 | global alpha, the middle the |
| | | SOURCE | 010 | source alpha and the upper the |
| | | GLOBAL_SOURCE | 011 | alpha mask. The value of |
| | | MASK | 100 | those bits decides the blend |
| | | GLOBAL_MASK | 101 | equation. |
| | | SOURCE_MASK | 110 | |
| | | GLOBAL_SOURCE_MASK | 111 | |

| | | |
|---|---|---|
| Reserved_13 | 13 bits | Empty space to align slot |

### 10. Refresh Information Slot

Total size of a refresh information slot: 36 bytes

### Refresh Information Slot Structure

| Parameter | Data type | Comment | |
|---|---|---|---|
| Header | 8 bits | 0xA0 | |
| Output to | 1 bit | 0x0 | Output to Display disable |
| Display | | 0x1 | Output to Display enable |

| | | Color format on which the tile should be sent to the display (only | |
|---|---|---|---|
| | | used when Output to Display parameter is enabled | |
| | | Name | Code |
| Output | 3 bits | RGB888 | 0x0 |
| Color | (ENUM) | RGB565 | 0x1 |
| format | | RGB666_LOOSE | 0x2 |
| | | RGB666_PACKED | 0x3 |
| | | RGB10_10_10 | 0x4 |
| | | YUV422_INT | 0x5 |
| | | YUV444_INT | 0x6 |
| | | YUV444_10BITS | 0x7 |

| | | The REVERSE mode can be used to match the DCS protocol, | | |
|---|---|---|---|---|
| | | together with the comp_x_pos parameters below. (only used when | | |
| | | Output to Display parameter is enabled) | | |
| Order_565 | 1 bit | 0x0 | NORMAL | LSbyte sent first |
| | | 0x1 | REVERSE | Msbyte sent first |
| Output to | 1 bit | 0x0 | Output to External RAM disable | |
| external | | 0x1 | Output to External RAM enable | |
| memory | | | | |
| | | When internal tile format is YUV422 and output to external | | |
| | | memory enable, this parameter selects the format of the data in | | |
| | | memory | | |
| YUV422_conversion | 2 bits | 0x0 | YUV422_INT | |
| | | 0x1 | YUV420_2_PLANED | |
| | | 0x2 | YUV420_MB | |
| Comp 0 pos | 2 bits | Position of the color components in the data stream sent to the | | |
| Comp 1 pos | 2 bits | display. (Applies to RGB & YUV formats). The value at | | |
| Comp 2 pos | 2 bits | comp_0_pos will be the order of the LSComp. in the internal tile | | |
| Comp 3 pos | 2 bits | format | | |
| | | This parameter is only used to map the MIPI standard that might | | |
| | | require certain length alignment for some formats (e.g. 30 bits for | | |
| | | RGB666) | | |
| Pad packed | 1 bit | 0x0 | OFF | Indicates if 0s should be |
| pixels | | 0x1 | ON | added to byte align the |
| | | | | scanline transfers to display. |
| | | | | (only used when Output to |
| | | | | Display parameter is |
| | | | | enabled) |
| Before | 1 bit | 0x0 | OFF | Indicates when a sync |
| Frame Sync | | 0x1 | ON | signal should be set towards |
| After Frame | 1 bit | 0x0 | OFF | the display interface (Only |
| Sync | | 0x1 | ON | used when Output to |
| | | | | Display parameter is |
| | | | | enabled) |
| | | Name | Code | Description |
| Endianness | 1 bit | LITTLE_ ENDIAN | 0x0 | Endianness of the bits |
| | | BIG_ ENDIAN | 0x1 | inside the color component |
| | | | | of the output (Only used |
| | | | | when Output to Display |
| | | | | parameter is enabled) |
| Interleaved | 1 bit | 0x0 | OFF | No interleaved output |
| | | 0x1 | ON | Output to the display |
| | | | | should be interleaved |
| Field order | 1 bit | 0x0 | EVEN | When interleaved is ON, |
| | | | | send EVEN field first |
| | | 0x1 | ODD | When interleaved is ON, |
| | | | | send ODD field first |
| Data fetch | 2 bits | NORMAL | 0x0 | Single tile output |
| mode | | B2R_SINGLE | 0x1 | Uses B2R ptr and size |
| | | | | parameters |
| | | B2R_DOUBLE | 0x2 | Uses cluster size (several |
| | | | | tiles at the time) |
| | | ANTIFLICKER | 0x3 | Apply anti-flickering |
| | | | | (requires B2R double |
| | | | | buffer) |
| Output | 2 bits | NONE | 0x0 | No L2 cache nor virtual |
| external | | | | memory |
| memory | | L2 | 0x1 | Use L2 cache |
| source | | VM | 0x2 | Virtual memory enable |
| select | | L2_VM | 0x3 | L2 cache + virtual mem |
| SW cmd list | 2 bits | (only used when data_fetch_mode = NORMAL) | | |
| external | | NONE | 0x0 | No L2 cache nor |
| memory | | | | virtual memory |
| source | | L2 | 0x1 | Use L2 cache |
| select | | VM | 0x2 | Virtual memory enable |
| | | L2_VM | 0x3 | L2 cache + virtual |
| | | | | mem |
| SW cmd list | 4 bits | Distance between command streams in the cmd list buffer in | | |
| stride | | external memory (in number of 64-bit words). It will also be the | | |
| | | size of the command sent in front of each tile. Putting the value in | | |
| | | this slot restricts all SW cmd list buffers for one update to have the | | |
| | | same stride (only used when data_fetch_mode = NORMAL). | | |
| | | Indicates the size of the cmd list buffer in internal memory in the | | |
| | | number of times the stride fits (only used when | | |
| | | data_fetch_mode = NORMAL). | | |
| | | Code | | Description |
| SW cmd list | 2 bits | 0x0 | | 2_STRIDES |
| internal | | 0x1 | | 4_STRIDES |
| mem size | | 0x2 | | 8_STRIDES |
| | | 0x3 | | 16_STRIDES |
| | | Only used if Data Fetch mode is ANTIFLICKER and Output to | | |
| | | external memory is enable. If OPPOSITE_FIELD is selected, | | |
| | | interleaved should be ON. | | |
| | | Name | Code | Description |
| Anti-flicker | 1 bit | FULL_FRAME | 0x0 | Write all data to memory |
| external | | OPPOSITE_FIELD | 0x1 | Write only the field |
| memory | | | | opposite to the one sent to |
| Output type | | | | display in memory |

| | | |
|---|---|---|
| Reserved_0 | 5 bits | Empty space to align slot |
| B2R size | 16 bits | Number of tiles that fit in the B2R buffer (the amount needed to |
| | | complete a scanline, only used when |
| | | data_fetch_mode = B2R_SINGLE). |
| B2R | 16 bits | Length of the scanlines to be sent when working with B2R in |
| Scanline | | bytes. (Only used when data_fetch_mode ! = NORMAL). |
| Length | | |
| external | 16 bits | Stride of the external memory region in number of bytes (only |
| memory | | used when Output to external memory parameter is enabled) |
| stride | | |
| Output | 32 bits | Address of the External RAM region where the output of this |
| external | | partial update should be written (in case of separated YUV format, |
| memory | | this buffer will contain the Y component) (only used when Output |
| pointer | | to external memory parameter is enabled). |
| Output | 32 bits | In case of 2-planed YUV format, this buffer in external memory |
| external | | will contain the UV components (only used when Output to |
| memory UV | | external memory parameter is enabled). |
| pointer | | |
| Output | 20 bits | 64-bit word aligned byte address in internal memory of the |
| YUV420 | | temporal buffer where the YUV420 data will be written to before |
| gptr. | | being memcopy to external memory. This buffer will have a fixed |
| | | size. (Only used when Output to external memory parameter is |
| | | enabled and YUV422 _conversion ! = YUV422_INT) |
| Reserved _1 | 12 bits | Empty space to align slot |
| SW cmd list | 20 bits | 64-bit word aligned byte address of the temporal internal memory |
| gptr. | | buffer where tile commands will be stored. (Only used when |
| | | data_fetch_mode = NORMAL). |
| Reserved_2 | 12 bits | Empty space to align slot |
| B2R gptr. | 20 bits | 64-bit word aligned byte address in internal memory of the B2R |
| | | buffer (only used when data fetch mode = B2R_SINGLE). |
| Reserved _3 | 12 bits | Empty space to align slot |
| Anti-flicker | 20 bits | 64-bit word aligned byte address in internal memory of the table |
| filter gptr. | | used for anti-flicker filtering (only used when data_fetch_mode = |
| | | ANTIFLICKER) |
| Reserved_4 | 12 bits | Empty space to align slot |

It will be appreciated by those skilled in the art having the benefit of this disclosure that this display list mechanism for scalable display engines provides various advantages.

One advantage of embodiments of the invention is that the exemplary display list is not used for hardware processing block initialization or set-up functions, therefore the display list's structure remains the same regardless and independent of the number of frame threads that the display engine supports running in parallel or the number of processing blocks instantiated. This means that an exemplary display list can be employed with display engines of different sizes (targeting different platform segments) with substantially no adaptation design effort required.

Another advantage of various embodiments is the caching mechanism incorporated into various display engine embodiments along with there being no parameter duplication due to there being one place where a display list is written. Thus, memory size requirements are reduced in exemplary display engines (with respect to prior display engines) to a minimum amount of memory needed to program the display engine.

Yet, another advantage of embodiments is found in use of synchronization slots and the priority parameters found therein, which make it possible to synchronize processing of parallel frame.

It will be appreciated by those skilled in the art having the benefit of this disclosure that this display list mechanism for scalable display engines provides an interface between platform software and a display engine that allows a scalable display engine architecture to be designed and implemented separately from the design and implementation of the platform. An exemplary display list interface mechanism effectively eliminates the need for the platform or system to be interrupted by memory loads and processor interaction with various registers and processing blocks within its associated display engine. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A method of controlling a display engine, the method comprising:
providing, by software, a display list adapted to configure a plurality of display engine processing blocks, the display list comprising a plurality of slots adapted to instruct the plurality of display engine processing blocks to compose an image frame from source image data;
storing the display list in a memory;
using, by the display engine, at least one of the plurality of slots to process the source image data into the image frame; and
refreshing, by the display engine, a previous image frame with the image frame in accordance with at least one of the plurality of slots.

2. The method of controlling the display engine of claim 1, further comprising providing the image frame to a display engine output.

3. The method of controlling the display engine of claim 1, wherein the memory is an internal memory of the display engine.

4. The method of controlling the display engine of claim 1, wherein the step of providing the display list is performed by a display engine driver operating external to the display engine.

5. The method of controlling the display engine of claim 1, wherein the steps of providing, storing, using and refreshing are repeated for each image frame.

6. The method of controlling the display engine of claim 1, wherein at least one of the slots provides instructional information associated with how the display engine processes a plurality of tiles from the source image data.

7. The method of controlling the display engine of claim 1, wherein at least one of the slots provides parameters associated with how the display engine processes the source image data.

8. The method of controlling the display engine of claim 1, wherein at least one of the slots provides instructional information indicating a starting memory location of the source image data.

9. The method of controlling the display engine of claim 1, wherein each of the plurality of slots comprises a header that identifies a slot type.

10. The method of controlling the display engine of claim 1, further comprising providing the image frame to a memory location or an output device or both the memory location and the output device simultaneously.

11. A software interface between software and a display engine architecture, wherein the display engine architecture comprises a plurality of hardware processing blocks and an internal memory, the software interface comprising:
a memory portion of the internal memory; and
a first display list, configured according to a predetermined format, the first display list comprising a first plurality of slots, the first display list being adapted for storage in the memory portion, the first plurality of slots being adapted to set up the display engine architecture to process and format a first frame thread of source image data into a first image frame to be provided to a first predetermined display device.

12. The software interface between software and the display engine architecture of claim 11, wherein the display engine architecture is a scalable display engine architecture wherein the plurality of hardware processing blocks comprise:
at least one pixel pipeline block adapted to compose first individual image tiles from the first frame thread of source image data into first update tiles;
at least one tile FIFO adapted to receive the first update tiles from at least one of the pixel pipeline blocks;
at least one display refresh block adapted to receive and format the first update tiles from a selected one of the tile FIFOs into the first image frame; and
a scheduling block adapted, in accordance with the first display list, to control and synchronize movement of the first frame thread of source image data to the at least one pixel pipeline block, control and synchronize movement of the first update tiles to the at least one tile FIFO, control and synchronize movement of the first update tiles from the selected one of the tile FIFOs to the at least one refresh block, and movement of the first image frame to a selected display output.

13. The software interface of claim 12, wherein the scheduling block is further adapted to control and simultaneously synchronize movement of the first image frame to the first selected display output and to a second selected display output.

14. The software interface between software and the display engine architecture of claim 11, wherein the software is a display engine driver.

15. The software interface between software and the display engine architecture of claim 11, further comprising:
a second display list, configured according to the predetermined format, the second display list comprising a second plurality of slots, the second display list being adapted for storage in the memory portion, the second plurality of slots being adapted to set up the display engine architecture to process and format a second frame thread of source image data into a second image frame to be provided to a second predetermined display device.

16. The software interface between software and the display engine architecture of claim 11, wherein the first display list is a static display list, the static display list remains in the memory portion and is adapted to set up the display engine architecture to process and format a second frame thread of source image data into a second image frame to be provided to the first predetermined display device.

17. The software interface between software and the display engine architecture of claim 15, wherein the first predetermined display device and the second predetermined display device are the same display device.

18. The software interface between software and the display engine architecture of claim 15, wherein the display engine architecture is a scalable display engine architecture comprising:
at least two pixel pipeline blocks, wherein each pixel pipeline block is adapted to compose first update tiles from the first frame thread of source image data or to compose second update tiles from the second frame thread of source image data;
at least two tile FIFOs, wherein each tile FIFO is adapted to receive the first update tiles from at least one of the pixel pipeline blocks or to receive the second update tiles from at least one of the pixel pipeline blocks;
at least two display refresh blocks, wherein each display refresh block is adapted to receive first update tiles from a first selected one of the at least two tile FIFOs or to receive second update tiles from a second one of the at least two tile FIFOs, and wherein each display refresh block is further adapted to format first update tiles into first image frames and adapted to format second update tiles of the second frame into second image frames; and
a scheduling block adapted to control and synchronize operation of each pixel pipeline block and each display refresh block based on both the first display list and the second display list.

19. An interface between software and a display engine architecture, the interface comprising:
a display list memory adapted to receive and to store at least one display list;
a first display list provided by the software, the first display list being adapted to be stored in the display list memory, the first display list being associated with a first frame thread of source image data, the first display list comprising parameters adapted for use by the display engine architecture to set up the display engine architecture to process the first frame thread of source image data.

20. The interface between software and the display engine architecture of claim 19, wherein the display list memory is internal display engine memory.

21. The interface between software and the display engine architecture of claim 19, wherein the first display list comprises a plurality of slot types wherein each slot type comprises a predetermined format, and wherein each predetermined slot type comprises predetermined types of parameters.

22. The interface between software and the display engine architecture of claim 19, further comprising means for setting up the display engine architecture to process the first frame thread of source image data using the parameters of the first display list.

23. The interface between software and the display engine architecture of claim 19, wherein the first display list comprises parameters organized in accordance with a display engine interface standard adapted for use with the display engine architecture.

24. The interface between software and the display engine architecture of claim 19, further comprising a second display list provided by the software, the second display list being adapted to be stored the display list memory, the second display list being associated with a second frame thread of source image data, the second display list comprising second parameters adapted for use by the display engine architecture to set up the display engine architecture to process the second frame thread of source image data in parallel with the first frame thread of source image data.
